(19) United States
(12) Patent Application Publication
(10) Pub. No.: US 2014/0334386 A1
(43) Pub. Date: Nov. 13, 2014

(54) COMMUNICATION SYSTEM, GATEWAY APPARATUS, AND COMMUNICATION METHOD

(71) Applicant: SHARP KABUSHIKI KAISHA, Osaka-shi, Osaka (JP)

(72) Inventors: Hidenobu Fukumasa, Osaka-shi (JP); Shiro Sugahara, Osaka-shi (JP); Shuichi Takehana, Osaka-shi (JP); Shusaku Fukumoto, Osaka-shi (JP)

(21) Appl. No.: 14/372,840

(22) PCT Filed: Jan. 18, 2013
(86) PCT No.: PCT/JP2013/050924

§ 371 Date: Jul. 17, 2014

(30) Foreign Application Priority Data
Jan. 20, 2012 (JP) 2012-010407

(51) Int. Cl. H04W 8/26; H04W 4/00

(52) U.S. Cl. CPC H04W 8/26; H04W 4/005; H04W 88/16
USPC 370/328

(57) ABSTRACT

A first gateway apparatus includes: an apparatus determining unit configured to receive a connection request signal for requesting a connection from the second communication apparatus and identify at least one of the group and service based on the connection request signal; and a data transfer unit configured to transfer data received from the second communication apparatus to the second gateway apparatus.

### TECHNICAL FIELD

The present invention relates to a communication system, a gateway apparatus, and a communication method.

Priority is claimed on Japanese Patent Application No. 2012-010407, filed on Jan. 20, 2012, the content of which is incorporated herein by reference.

### BACKGROUND ART

In the past, machine type communication (MTC) (which is also called machine communication) autonomously performed between apparatuses without determination of users has been developed. In the machine type communication, attempts of wide-ranging applications such as remote management of vending machines or the like or management of usage fees of public interest services such as electric power or gas have been made. Non-Patent Document 1 discloses a type of wireless communication network including a plurality of MTC dedicated terminals (MTC apparatuses).

### PRIOR ART DOCUMENT

### Patent Document

### [Non-Patent Document 1]

3GPP TS 22.368 Service Requirements for Machine-Type Communications (MTC) Stage 1, 3GPP Organizational Partners, 2011.2, V10.3.1

### SUMMARY OF INVENTION

### Problem to Be Solved by the Invention

However, in the wireless communication network disclosed in Non-Patent Document 1, when the MTC apparatuses simultaneously request connection, signaling with a mobility management entity (MME) (a mobility management apparatus) performing mobility management of terminals is concentrated, and thus a load of the MME excessively increases, and processing eventually becomes congested. This causes transmission and reception of data to fail.

The present invention was made in light of the foregoing, and it is desirable to provide a communication system, a gateway apparatus, and a communication method, which are capable of reducing the load of the MME.

### Means to Solve the Problem

(1) The present invention was made to solve the above-described problem, and one aspect of the present invention is a communication system, including: a first gateway apparatus; a second gateway apparatus configured to transfer data received from the first gateway apparatus to a first communication apparatus related to at least one of a certain group and service; and a mobility management apparatus configured to perform a process of setting a communication path between a communication apparatus that transmits data and the second gateway apparatus, wherein, the first gateway apparatus includes: an apparatus determining unit configured to receive a connection request signal for requesting a connection from the second communication apparatus and identify at least one of the group and service based on the connection request signal; and a data transfer unit configured to transfer data received from the second communication apparatus to the second gateway apparatus.

(2) Another aspect of the present invention is the communication system described above, wherein the first gateway apparatus includes an address managing unit configured to allocate different addresses to the second communication apparatus.

(3) Another aspect of the present invention is the communication system described above, wherein the first gateway apparatus includes a control unit configured to transfer the connection request signal to the mobility management apparatus in case that at least one of the group and service is not identified.

(4) Another aspect of the present invention is the communication system described above, the communication system further including a third gateway apparatus, the third gateway apparatus including: an apparatus determining unit configured to receive a connection request signal for requesting a connection from the second communication apparatus and identify at least one of the group and service based on the connection request signal; and a corresponding information determining unit configured to decide the first gateway apparatus related to at least one of a group and service corresponding to at least one of the group and service.

(5) Another aspect of the present invention is a communication system, including: a relay apparatus; a base station apparatus configured to transfer data received from the relay apparatus; a gateway apparatus configured to transmit data received from the base station apparatus to a first communication apparatus; and a mobility management apparatus configured to perform a process of setting a communication path between a communication apparatus transmitting data and the gateway apparatus, wherein the relay apparatus includes: an apparatus determining unit configured to receive a connection request signal for requesting a connection from the second communication apparatus and identify at least one of the group and service based on the connection request signal; and a data transfer unit configured to transfer data received from the second communication apparatus to the gateway apparatus.

(6) Another aspect of the present invention is the communication system described above, wherein the relay apparatus includes a control unit configured to decide the number of communication apparatuses to be accommodated based on at least one of the number of communication apparatuses present and a communication capability of the communication apparatuses.

(7) Another aspect of the present invention is the communication system described above, wherein the relay apparatus includes a control unit configured to decide a service quality for communication apparatuses to be accommodated based on at least one of the number of communication apparatuses present and a communication capability of the communication apparatuses.

(8) Another aspect of the present invention is the communication system described above, wherein the relay apparatus includes a control unit configured to decide whether to transfer data received only from a communication apparatus related to at least one of the group and service based on at least one of the number of communication apparatuses present and a communication capability of the communication apparatuses.

(9) Another aspect of the present invention is a gateway apparatus, including: a registration processing unit configured to transmit a registration request signal representing that a communication apparatus transmitting data requests a registration to a mobility management apparatus that performs a process of setting a communication path between the communication apparatus and another gateway apparatus; a connection processing unit configured to establish the communication path with the other gateway apparatus after the mobility management apparatus sets the communication path; and a data transfer unit configured to transfer data received from a communication apparatus related to at least one of a certain group and service to the other gateway apparatus.

(10) Another aspect of the present invention is a communication method in a communication system including a first gateway apparatus, a second gateway apparatus configured to transfer data received from the first gateway apparatus to a first communication apparatus related to at least one of a certain group and service, and a mobility management apparatus configured to perform a process of setting a communication path between a communication apparatus that transmits data and the second gateway apparatus, the communication method including: receiving, by the first gateway apparatus, a connection request signal for requesting a connection from the communication apparatus and identifying at least one of the group and service based on the connection request signal, and transferring, by the first gateway apparatus, data received from the communication apparatus to the second gateway apparatus.

### Effect of the Invention

According to the embodiments of the present invention, an effect of reducing a load of a mobility management apparatus (MME) performing terminal management in a wireless communication system is obtained.

### BRIEF DESCRIPTION OF THE DRAWINGS

FIG. 1 is a schematic diagram illustrating a communication system according to a first embodiment of the present invention.

FIG. 2 is a schematic diagram illustrating a constitution of a base station apparatus according to the present embodiment.

FIG. 3 is a schematic diagram illustrating a constitution of an MTC-GW unit according to the present embodiment.

FIG. 4 is a diagram illustrating exemplary MTC service information according to the present embodiment.

FIG. 5 is a diagram illustrating exemplary MTC group information according to the present embodiment.

FIG. 6 is a diagram illustrating exemplary address information according to the present embodiment.

FIG. 7 is a schematic diagram illustrating a constitution of an MTC terminal apparatus according to the present embodiment.

FIG. 8 is a sequence diagram illustrating a communication process performed by a communication system according to the present embodiment.

FIG. 9 is a schematic diagram illustrating a communication system according to a second embodiment of the present invention.

FIG. 10 is a schematic diagram illustrating a constitution of a base station apparatus according to the present embodiment.

FIG. 11 is a schematic diagram illustrating an MTC-GW apparatus according to the present embodiment.

FIG. 12 is a sequence diagram illustrating a communication process performed by a communication system according to the present embodiment.

FIG. 13 is a schematic diagram illustrating a communication system according to a third embodiment of the present invention.

FIG. 14 is a schematic diagram illustrating a constitution of an MTC-GW unit according to the present embodiment.

FIG. 15 is a diagram illustrating exemplary corresponding MTC group information according to the present embodiment.

FIG. 16 is a sequence diagram illustrating a communication process performed by a communication system according to the present embodiment.

FIG. 17 is a schematic diagram illustrating a communication system according to a fourth embodiment of the present invention.

FIG. 18 is a schematic diagram illustrating a constitution of an RN apparatus according to the present embodiment.

FIG. 19 is a sequence diagram illustrating a communication process performed by a communication system according to the present embodiment.

FIG. 20 is a conceptual diagram illustrating a constitution of a communication system according to a fifth embodiment of the present invention.

FIG. 21 is a sequence diagram illustrating a communication process performed by a communication system according to the present embodiment.

### EMBODIMENT FOR CARRYING OUT THE INVENTION

### First Embodiment

Hereinafter, a first embodiment of the present invention will be described with reference to the appended drawings.

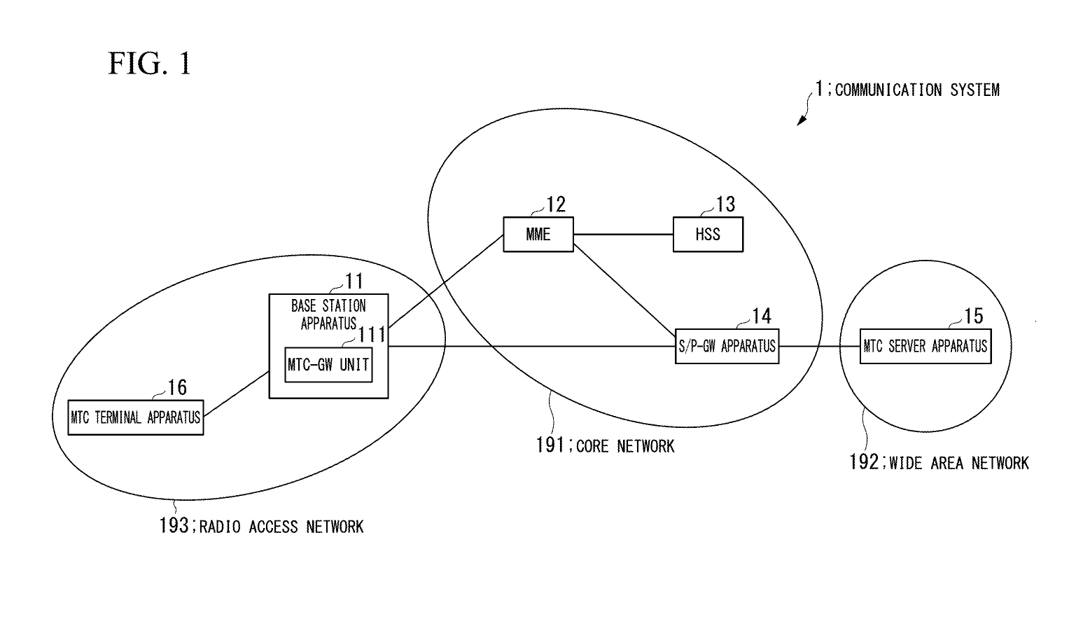

FIG. 1 is a schematic diagram illustrating a communication system 1 according to the present embodiment.

The communication system 1 is a wireless communication system based on a Long Term Evolution (LTE) network representing a wireless communication network. The communication system 1 is configured to include a base station apparatus (eNB) 11, a mobility management entity (MME) 12, a home subscriber server (HSS) (a subscriber apparatus) 13, a serving gateway (gateway apparatus)/packet data network [PDN] gateway (S/P-GW) (packet data network) apparatus 14, an MTC server apparatus 15, an MTC terminal apparatus 16, a core network (CN) (which is also called system architecture evolution (SAE)) 191, a wide area network 192, and a radio access network (RAN) 193.

The core network 191 is a network (for example, a wired backbone network) connecting the MME 12, the HSS 13, and the S/P-GW apparatus 14 with one another.

The wide area network 192 is a network (for example, the Internet) including the MTC server apparatus 15 as a constituent element (entity).

The radio access network 193 is a network that makes a wireless connection (for example, a radio resource control (RRC) connection) between the MTC terminal apparatus 16 and the base station apparatus 11.

The base station apparatus 11 includes an MTC gateway (MTC-GW) unit 111. The MTC-GW unit 111 transmits a registration request signal to the MME 12, and establishes a communication path with the S/P-GW apparatus 14. The registration request signal is a signal for requesting the registration of an apparatus performing communication. The MTC-GW unit 111 transmits a data packet related to an MTC group or an MTC service received from the MTC terminal apparatus 16 to the MTC server apparatus 15 corresponding to the MTC group or the MTC service through the S/P-GW apparatus 14. The S/P-GW apparatus 14 includes a serving gateway (S-GW) apparatus and a packet data network (PDN) gateway (P-GW) apparatus. The S-GW apparatus and the P-GW apparatus are generally separate apparatuses, but are herein collectively referred to as an S/P-GW apparatus for simplification. A detailed constitution of the base station apparatus 11 will be described later.

The MME 12 receives the registration request signal from the MTC-GW unit 111. The MME 12 transmits a user inquiry signal for querying whether a transmission source apparatus (the MTC-GW unit 111 in the example illustrated in FIG. 1) related to the registration request signal is an authorized user to the HSS 13. When user information received from the HSS 13 as a response represents that the transmission source apparatus is the authorized user, the MME 12 generates a bearer setting request signal, and transmits the generated bearer setting request signal to the S/P-GW apparatus 14. The bearer setting request signal generated by the MME 12 is a signal for requesting a setting of a bearer (communication path) between the transmission source apparatus (the MTC-GW unit 111 in the example illustrated in FIG. 1) and the S/P-GW apparatus 14.

The MME 12 extracts bearer information from a bearer setting response signal received from the S/P-GW apparatus 14. The MME 12 generates a registration acceptance signal representing that the registration of the transmission source apparatus (the MTC-GW unit 111 in the example illustrated in FIG. 1) has been accepted. The registration acceptance signal includes the extracted bearer information. The MME 12 transmits the generated registration acceptance signal to the MTC-GW unit 111. When the user information received from the HSS 13 represents that the transmission source apparatus is not the authorized user, the MME 12 generates a registration failure signal representing that the registration of the transmission source apparatus has failed. The MME 12 transmits the generated registration failure signal to the MTC-GW unit 111.

The HSS 13 includes a user information storage unit that stores user information representing apparatuses used by the authorized users. The HSS 13 searches for an apparatus (the MTC-GW unit 111 or base station apparatus eNB in the example illustrated in FIG. 1) represented by the user inquiry signal received from the MME 12 from the user information storage unit. When the user information representing the apparatus identical to the apparatus represented by the user inquiry signal is detected from the user information storage unit, the HSS 13 generates the user information representing that it is the authorized user. When the user information representing the apparatus identical to the apparatus represented by the user inquiry signal is not detected from the user information storage unit, the HSS 13 generates the user information representing that it is not the authorized user. The HSS 13 transmits the generated user information to the MME 12.

The S/P-GW apparatus 14 sets a bearer with the transmission source apparatus (the MTC-GW unit 111 in the example illustrated in FIG. 1) represented by the bearer setting request signal received from the MME 12. Here, the S/P-GW apparatus 14 generates bearer information including an address of the transmission source apparatus and an address of the S/P-GW apparatus 14. After the bearer setting is completed, the S/P-GW apparatus 14 generates the bearer setting response signal representing that the bearer setting has been completed. The bearer setting response signal includes the generated bearer information. The S/P-GW apparatus 14 transmits the generated bearer setting response signal to the MME 12.

The S/P-GW apparatus 14 transfers a service setting information request signal received from the MTC-GW unit 111 to a transmission destination apparatus (the MTC server apparatus 15 in the example illustrated in FIG. 1). The service setting information request signal is a signal for requesting the transmission destination apparatus to provide service setting information. The service setting information is setting information used to provide the MTC service.

The S/P-GW apparatus 14 transmits the service setting information received from the MTC server apparatus 15 to the MTC-GW unit 111.

The S/P-GW apparatus 14 removes a tunneling header from the data packet received from the MTC-GW unit 111, and transmits the data packet from which the tunneling header has been removed to the MTC server 15. The tunneling header includes the address of the transmission source apparatus serving as a tunneling start point and the address of the transmission destination apparatus serving as a tunneling end point. The data packet to be transmitted to the MTC server apparatus 15 includes an address of the MTC server apparatus 15 as a transmission destination address.

The MTC server apparatus 15 is a server apparatus belonging to a certain MTC group or a server apparatus belonging to a certain MTC service. The MTC group refers to a group including a group of apparatuses related to certain machine type communication (MTC). The MTC service refers to a service provided as the MTC is performed.

The MTC server apparatus 15 stores service setting information related to a service provided as the MTC is performed. The service setting information differs according to a service to be provided. For example, when a corresponding service is a parking lot monitoring service, the service setting information is information of a coding scheme used to encode an image signal representing an image of a parking lot. After receiving the service setting information request signal from the S/P-GW apparatus 14, the service setting information is transmitted to the MTC-GW unit 111 through the S/P-GW apparatus 14.

The MTC server apparatus 15 extracts data generated by the MTC terminal apparatus 16 from the data packet received from the S/P-GW apparatus 14. The MTC server apparatus 15 includes a functional unit that performs certain processing using the extracted data. For example, when the extracted data is an image signal representing an image of a parking lot around the MTC terminal apparatus 16, the MTC server apparatus 15 may include a display unit that displays an image based on an image signal. For example, when the extracted data is a measurement value measured by a sensor equipped in the MTC terminal apparatus 16, the MTC server apparatus 15 may include a data editing unit that edits the measurement value or a data display unit that illustrates the measurement value.

The MTC terminal apparatus 16 is a terminal apparatus related to a certain MTC group or a terminal apparatus related to a certain MTC service. The MTC terminal apparatus 16 establishes a connection with the MTC-GW unit 111. The MTC terminal apparatus 16 generates data related to the MTC group to be transmitted to another apparatus or data related to the MTC service, and transmits a data packet including the generated data to the MTC server apparatus 15 through the MTC-GW unit 111 and the S/P-GW apparatus 14.

A more detailed constitution of the MTC terminal apparatus 16 will be described later.

Next, a constitution of the base station apparatus 11 according to the present embodiment will be described.

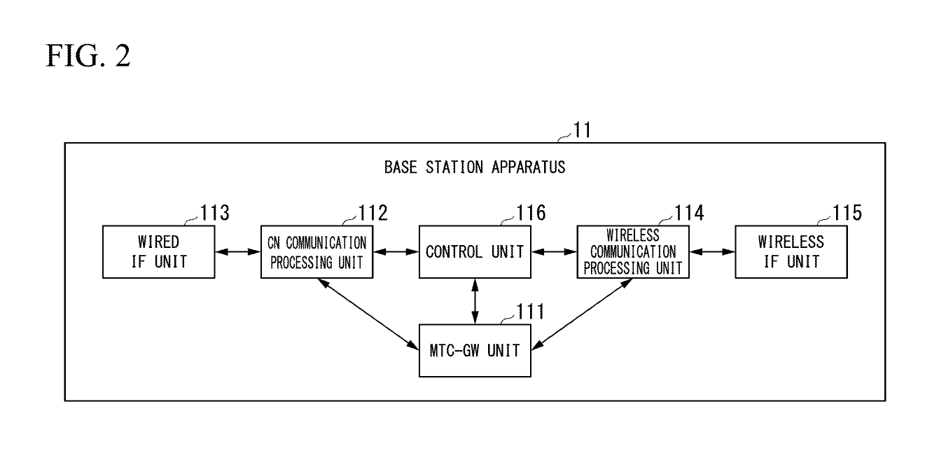

FIG. 2 is a schematic diagram illustrating a constitution of the base station apparatus 11 according to the present embodiment.

The base station apparatus 11 is configured to include the MTC-GW unit 111, a CN communication processing unit 112, a wired interface (IF) unit 113, a wireless communication processing unit 114, a wireless IF unit 115, and a control unit 116. In other words, the base station apparatus 11 functions as an MTC-GW apparatus as a whole.

A more detailed constitution of the MTC-GW unit 111 will be described later.

The CN communication processing unit 112 converts a transmission signal input from the MTC-GW unit 111 or the control unit 116 into a certain format, and outputs the converted transmission signal to the wired IF unit 113. This format is a format (for example, an optical signal) in which the core network 191 transmits and receives the transmission signal.

The CN communication processing unit 112 converts a reception signal input from the wired IF unit 113 into a certain format, and outputs the converted reception signal to the MTC-GW unit 111 or the control unit 116. This format is a format in which the MTC-GW unit 111 or the control unit 116 processes the reception signal.

The wired IF unit 113 is an input/output (I/O) interface physically connected with the core network 191 in a wired manner. The wired IF unit 113 transmits a transmission signal input from the CN communication processing unit 112 to an apparatus connected to a corresponding network through the core network 191. The wired IF unit 113 receives a reception signal from an apparatus connected to the core network 191 via a corresponding network. The wired IF unit 113 outputs the received reception signal to the CN communication processing unit 112.

The wireless communication processing unit 114 converts the transmission signal input from the MTC-GW unit 111 or the control unit 116 into a transmission signal of a radio frequency band, and outputs the converted transmission signal of the radio frequency band to the wireless IF unit 115. The wireless communication processing unit 114 converts the reception signal of the radio frequency band input from the wireless IF unit 115 into a reception signal of a base frequency band, and outputs the converted reception signal to the MTC-GW unit 111 or the control unit 116.

The wireless IF unit 115 is an interface for wirelessly transmitting and receiving a signal with the MTC terminal apparatus 16 or another user terminal apparatus. The wireless IF unit 115 transmits the transmission signal input from the wireless communication processing unit 113 to an apparatus (the MTC terminal apparatus 16 in the example illustrated in FIG. 1) wirelessly connected thereto. The wireless IF unit 115 receives a reception signal from an apparatus wirelessly connected thereto via a corresponding network. The wireless IF unit 115 outputs the received reception signal to the wireless communication processing unit 114.

The control unit 116 performs the same process as a control unit equipped in the base station apparatus 11 according to the related art. Here, when a connection request signal serving as the reception signal input from the wireless communication processing unit 114 includes an MTC apparatus identifier, MTC group information, or MTC service information, the control unit 116 instructs the MTC-GW unit 111 to process the input connection request signal. This operation causes the MTC-GW unit 111 to start processing related to the connection request from the MTC terminal apparatus 16.

Further, the control unit 116 transmits the connection request signal transmitted by the typical terminal apparatus to the MME 12, and in the communication system 1, processing related to a setting of a communication path and a connection between the terminal apparatus and the S/P-GW is performed each time.

Next, a constitution of the MTC-GW unit 111 according to the present embodiment will be described.

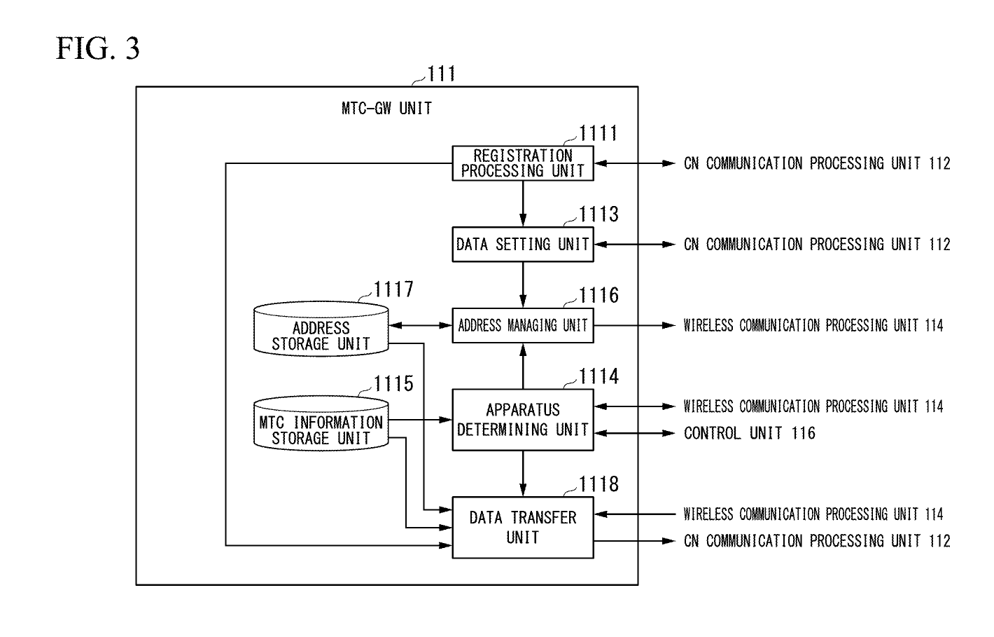

FIG. 3 is a schematic diagram illustrating a constitution of the MTC-GW unit 111 according to the present embodiment.

The MTC-GW unit 111 includes a registration processing unit 1111, a data setting unit 1113, an apparatus determining unit 1114, an MTC information storage unit 1115, an address managing unit 1116, an address storage unit 1117, and a data transfer unit 1118.

The registration processing unit 1111 generates the registration request signal, and outputs the generated registration request signal to the CN communication processing unit 112 as the transmission signal to be transmitted to the MME 12. The reception signal is input to the registration processing unit 1111 from the CN communication processing unit 112 as the registration acceptance signal received from the MME 12.

The registration processing unit 1111 extracts the bearer information from the registration acceptance signal, and outputs the extracted bearer information to the data transfer unit 1118.

The data setting unit 1113 outputs the transmission signal to the CN communication processing unit 112 as the service setting information request signal to be transmitted to the S/P-GW apparatus 14.

The reception signal is input to the data setting unit 1113 from the CN communication processing unit 112 as the service setting information received from the S/P-GW apparatus 14. The data setting unit 1113 sets the receive service setting information. A process of setting the service setting information differs according to the MTC service or the MTC group. For example, when the service setting information is information representing an image coding scheme used in a parking lot monitoring service, the data setting unit 1113 outputs the service setting information to the apparatus determining unit 1114. When the MTC service information representing the service is read as will be described later, the apparatus determining unit 1114 outputs the service setting information to the wireless communication processing unit 114 as the transmission signal to be transmitted to the MTC terminal apparatus 16.

Through this operation, data can be transmitted and received between the transmission source apparatus (the MTC terminal apparatus 16 in the example of FIG. 1) and the transmission destination apparatus (the MTC server apparatus 15 in the example of FIG. 1).

The reception signal is input to the apparatus determining unit 1114 from the wireless communication processing unit 114 as the connection request signal received from the MTC terminal apparatus 16. The apparatus determining unit 1114 extracts an apparatus identifier identifying the MTC terminal apparatus 16 and an MTC group identifier or an MTC service identifier from the received connection request signal.

The apparatus determining unit 1114 reads the MTC service information or the MTC group information corresponding to the extracted MTC service identifier or the MTC group identifier from the MTC information storage unit 1115. The MTC service information or the MTC group information may be stored in the MTC information storage unit 1115 in advance. The MTC service information refers to information associated with the MTC service identifier, service name information, and address information (the transmission destination address) of the transmission destination apparatus. The MTC group information is information associated with the MTC group identifier, group name information, and the transmission destination address information.

When the MTC service information or the MTC group information is successfully read, the apparatus determining unit 1114 outputs the extracted apparatus identifier and the read transmission destination address information to the address managing unit 1116.

After the apparatus identifier and the transmission destination address information are input from the apparatus determining unit 1114, the address managing unit 1116 generates address information different from all transmission source address information stored in the address storage unit 1117. Through this operation, address information specific to the MTC terminal apparatus 16 is generated. The address managing unit 1116 stores the apparatus identifier, the generated transmission source address information, the input transmission destination address information, and last reception time information at which a signal is lastly received from the MTC terminal apparatus 16 in the address storage unit 1117 in association with one another.

The address managing unit 1116 generates a connection response signal including the generated transmission source address information, and outputs the generated connection response signal to the wireless communication processing unit 114 as the transmission signal to be transmitted to the MTC terminal apparatus 16.

When a signal is not received from the MTC terminal apparatus 16 even after a certain period of time (for example, one hour) elapses from the last reception time, the address managing unit 1116 deletes the corresponding apparatus identifier, the transmission source address information, the input transmission destination address information, and the last reception time information which are stored in the address storage unit 1117. Through this operation, the generated transmission source address information is invalidated.

The data transfer unit 1118 receives data packet received from a communication processing unit 163 of the MTC terminal apparatus 16 from the wireless communication processing unit 114 as the reception signal. The data transfer unit 1118 extracts the transmission source address information from the received data packet, and determines whether or not there is the transmission source address information identical to the extracted transmission source address information in the address storage unit 1117.

When there is the transmission source address information identical to the extracted transmission source address information in the address storage unit 1117, it means that the MTC terminal apparatus 16 serving as the transmission source relates to a certain MTC service or a certain MTC group.

The data transfer unit 1118 reads the transmission destination address information corresponding to the extracted transmission source address information from the address storage unit 1117.

The bearer information is input to the data transfer unit 1118 from the registration processing unit 1111.

The data transfer unit 1118 replaces the transmission destination address information included in the data packet received from the MTC terminal apparatus 16 with the read transmission destination address information (the address information of the MTC server apparatus 15 in the example of FIG. 1).

The data transfer unit 1118 generates a tunneling header including the address information of the transmission source apparatus (for example, the MTC-GW unit 111) represented by the input bearer information and address information of the transmission destination apparatus (for example, the S/P-GW apparatus 14), and generates a new data packet by adding the generated tunneling header to the received data packet.

The data transfer unit 1118 outputs the generated data packet to the CN communication processing unit 112 as the transmission signal to be transmitted to the S/P-GW apparatus 14. Through this operation, tunneling is performed between the MTC-GW unit 111 and the S/P-GW apparatus 14.

Next, the MTC service information according to the present embodiment will be described.

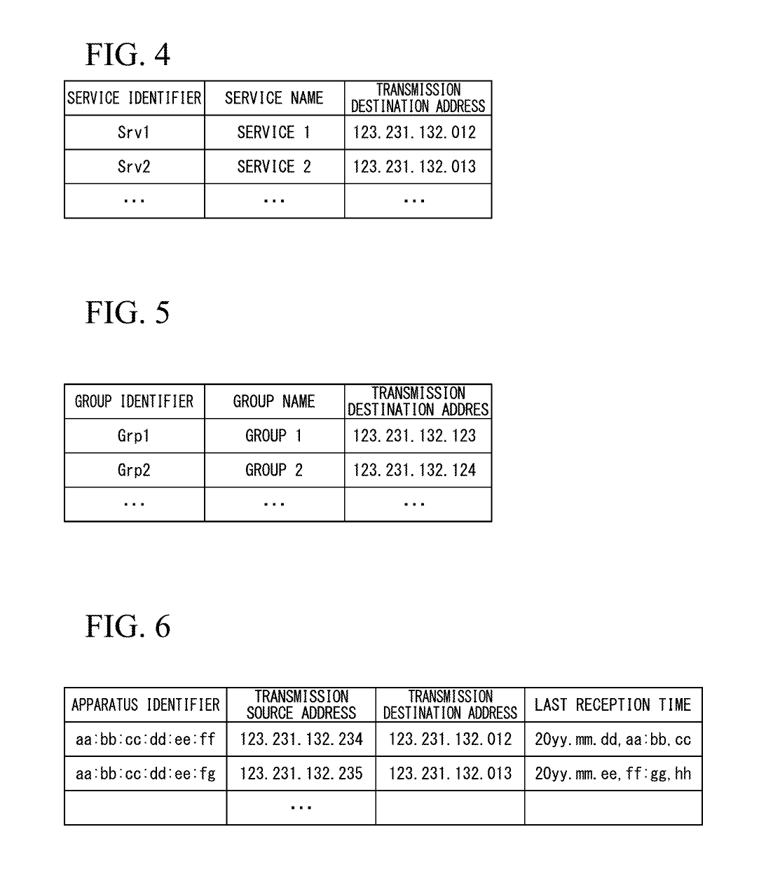

FIG. 4 is a diagram illustrating exemplary MTC service information according to the present embodiment.

FIG. 4 illustrates the service identifier, the service name information, and the transmission destination address information in order from the leftmost end to the right side. In FIG. 4, in a second row from an uppermost row, a service 1 is shown as the service name information corresponding to a service identifier Srv1, and 123.231.132.012 is shown as the transmission destination address information. In FIG. 4, in a third row from the uppermost row, a service 2 is shown as the service name information corresponding to a service identifier Srv2, and 123.231.132.013 is shown as the transmission destination address information.

Next, the MTC group information according to the present embodiment will be described.

FIG. 5 is a diagram illustrating exemplary MTC group information according to the present embodiment.

FIG. 5 illustrates the group identifier, the group name information, and the transmission destination address information in order from the leftmost end to the right side. In FIG. 5, in a second row from an uppermost row, a group 1 is shown as the group name information corresponding to a group identifier Grp1, and 123.231.132.123 is shown as the transmission destination address information. In FIG. 5, in a third row from the uppermost row, a group 2 is shown as the group name information corresponding to a group identifier Grp2, and 123.231.132.124 is shown as the transmission destination address information.

Next, address information according to the present embodiment will be described.

FIG. 6 is a diagram illustrating exemplary address information according to the present embodiment.

FIG. 6 illustrates the apparatus identifier, the transmission source address information, the transmission destination address information, and the last reception time information in order from the leftmost end to the right side.

In FIG. 6, in a second row from an uppermost row, in association with an apparatus identifier aa:bb:cc:dd:ee:ff, 123.231.132.234 is shown as the transmission source address information, 123.231.132.012 is shown as the transmission destination address information, and 20yy (year), mm (month), dd (date), aa (hour), bb (minute), and cc (second) is shown as the last reception time information.

In FIG. 6, in a third row from the uppermost row, in association with an apparatus identifier aa:bb:cc:dd:ee:fg, 123.231.132.235 is shown as the transmission source address information, 123.231.132.013 is shown as the transmission destination address information, and 20yy (year), mm (month), dd (date), ee (hour), ff (minute), and gg (second) is shown as the last reception time information.

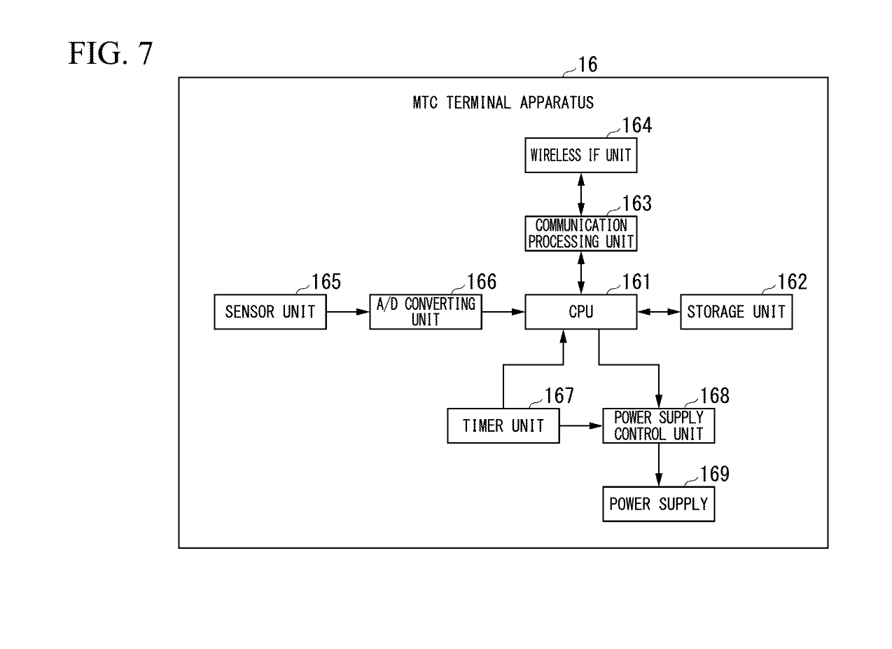

FIG. 7 is a schematic diagram illustrating a constitution of the MTC terminal apparatus 16 according to the present embodiment.

The MTC terminal apparatus 16 is configured to include a central processing unit (CPU) 161, a storage unit 162, the communication processing unit 163, the wireless TF unit 164, the sensor unit 165, an analog-to-digital (A/D) converting unit 166, a timer unit 167, a power supply control unit 168, and a power supply 169.

When an activation instruction signal is input from the power supply control unit 168, the CPU 161 reads a program stored in the storage unit 162, operates the read program, and controls an operation of the entire MTC terminal apparatus 16.

The CPU 161 reads the apparatus identifier and the MTC group identifier or the MTC service identifier which are stored in advance from the storage unit 162. The CPU 161 generates the connection request signal including the read apparatus identifier and the MTC group identifier or the MTC service identifier. The CPU 161 outputs the generated connection request signal to the communication processing unit 163 as the transmission signal to be transmitted to the apparatus determining unit 1114 of the MTC-GW unit 111.

The CPU 161 outputs digital data input from the A/D converting unit 165 to the communication processing unit 163 as the transmission signal to be transmitted to the data transfer unit 1118 of the MTC-GW unit 111.

When a stop instruction signal is input from the power supply control unit 168, the CPU 161 stops an operation of a program being operated, and stops operations the components other than the timer unit 167 and the power supply control unit 168.

The communication processing unit 163 processes the reception signal of the base frequency band input from the wireless IF unit 164 to generate an information signal sequence or a control information sequence, and outputs the generated information signal sequence or control information sequence to the CPU 161.

The communication processing unit 163 outputs the transmission signal input from the CPU 161 to the wireless IF unit 164 as the transmission signal of the base frequency band to be transmitted to the base station apparatus 11.

The wireless IF unit 164 performs down-conversion on the reception signal received from the base station apparatus 11 (the MTC-GW unit 111) through radio waves to generate the reception signal of the base frequency band, and outputs the generated reception signal of the base frequency band to the communication processing unit 163. The wireless IF unit 164 performs up-conversion on the transmission signal of the base frequency band input from the communication processing unit 163 to generate the transmission signal of the radio frequency band. The wireless IF unit 164 amplifies power of the generated transmission signal in the radio frequency domain, and outputs the amplified transmission signal to the base station apparatus 11 (the MTC-GW unit 111) through radio waves.

The sensor unit 165 detects analog data representing a surrounding environment of the MTC terminal apparatus 16.

The sensor unit 165 corresponds to, for example, a camera that captures an image or a temperature sensor that measures the temperature. The sensor unit 165 outputs the detected analog data to the A/D converting unit 166.

The A/D converting unit 166 performs A/D conversion on the analog data input from the sensor unit 165 to generate digital data. The A/D converting unit 166 outputs the generated digital data to the CPU 161.

The timer unit 167 sequentially measures a current time, and outputs the measured time information to the CPU 161 and the power supply control unit 168.

The power supply control unit 168 sets scheduling information representing information related to an activation time to activate the power supply 169 and a stop time to stop the power supply 169 in advance. Here, “stop” means a state in which the timer unit 167 and the power supply control unit 168 operate but the remaining functional portions stop.

When time information input from the timer unit 167 reaches the activation time represented by the scheduling information, the power supply control unit 168 generates an activation instruction signal representing activation. When the time information input from the timer unit 167 reaches the stop time represented by the scheduling information, the power supply control unit 168 generates an activation instruction signal representing stop. The power supply control unit 168 outputs the generated activation instruction signal or the stop instruction signal to the CPU 161 and the power supply 169.

In the stop state, the power consumption of the MTC terminal apparatus 16 is significantly smaller than the power consumption in the operation state (for example, less than 1/1000). Thus, when a time zone in which data is transmitted and received is scheduled, the scheduling information may be set so that the MTC terminal apparatus 16 is mainly activated only during the time zone in which data is transmitted and received, and is not activated during time zones in which data is not transmitted and received. Through this operation, the power consumption of the MTC terminal apparatus 16 can be conserved.

When the activation instruction signal is input from the power supply control unit 168, the power supply 169 supplies electric power to the respective components of the MTC terminal apparatus 16. After the stop instruction signal is input from the power supply control unit 168 and the operation of the CPU 161 stops, the power supply 169 stops supply of electric power to the respective components except the timer unit 167 and the power supply control unit 168.

Next, a communication process performed by the communication system 1 according to the present embodiment will be described.

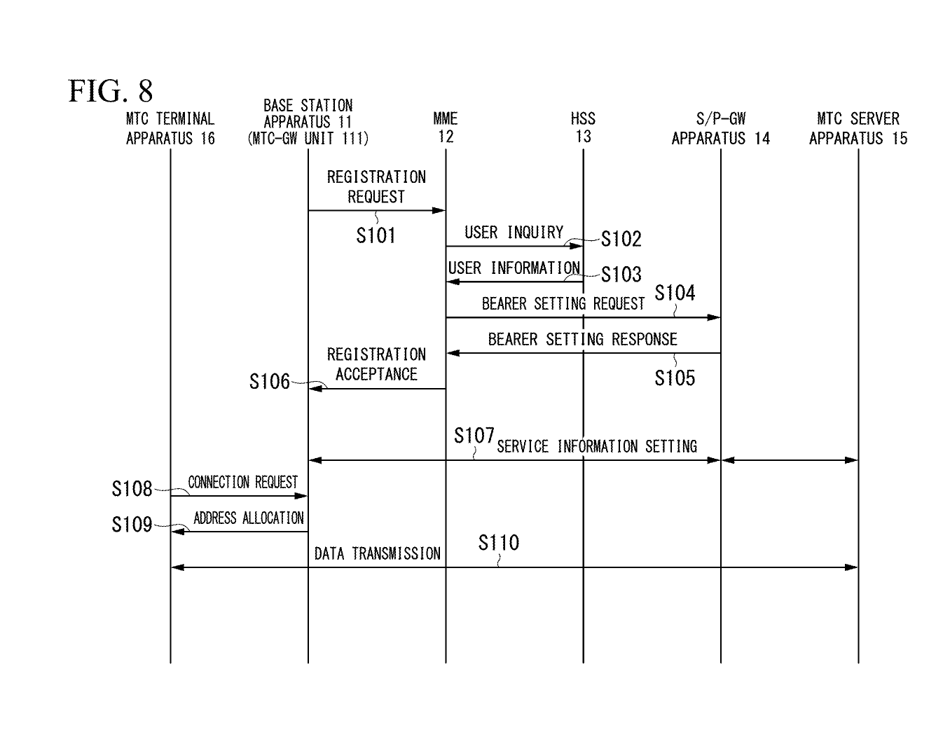

FIG. 8 is a sequence diagram illustrating a communication process performed by the communication system 1 according to the present embodiment.

(Step S101) The registration processing unit 1111 equipped in the MTC-GW unit 111 generates the registration request signal, and transmits the generated registration request signal to the MME 12. The MME 12 receives the registration request signal from the MTC-GW unit 111. Thereafter, the process proceeds to step S102.

(Step S102) The MME 12 transmits the user inquiry signal for querying whether the MTC-GW unit 111 serving as the transmission source apparatus related to the registration request signal is the authorized user to the HSS 13. The HSS 13 receives the user inquiry signal from the MME 12. Thereafter, the process proceeds to step S103.

(Step S103) The HSS 13 generates the user information representing that the MTC-GW unit 111 is the authorized user when the user information representing the apparatus identical to the MTC-GW unit 111 which is the apparatus represented by the user inquiry signal is detected from the user information storage unit. The HSS 13 transmits the generated user information to the MME 12. The MME 12 receives the user information from the HSS 13. Thereafter, the process proceeds to step S104.

(Step S104) The MME 12 generates the bearer setting request signal, and transmits the generated bearer setting request signal to the S/P-GW apparatus 14. The S/P-GW apparatus 14 receives the bearer setting request signal from the MME 12. Thereafter, the process proceeds to step S104.

(Step S105) The S/P-GW apparatus 14 receives the bearer setting request signal from the MME 12. The S/P-GW apparatus 14 generates the bearer information representing the bearer between the MTC-GW unit 111 represented by the bearer setting request signal and the S/P-GW apparatus. The S/P-GW apparatus 14 generates the bearer setting response signal including the generated bearer information, and transmits the generated bearer setting response signal to the MME 12. The MME 12 receives the bearer setting response signal from the S/P-GW apparatus 14. Thereafter, the process proceeds to step S106.

(Step S106) The MME 12 extracts the bearer information from the received bearer setting response signal. The MME 12 generates the registration acceptance signal including the extracted bearer information. The MME 12 transmits the generated registration acceptance signal to the registration processing unit 1111 of the MTC-GW unit 111. The registration processing unit 1111 of the MTC-GW unit 111 receives the registration acceptance signal from the MME 12. The registration processing unit 1111 extracts the bearer information from the registration acceptance signal, and outputs the extracted bearer information to the data transfer unit 1118. Thereafter, the process proceeds to step S107.

(Step S107) The data setting unit 1113 of the MTC-GW unit 111 generates the service setting information request signal, and transmits the generated service setting information request signal to the MTC server apparatus 15 via the S/P-GW apparatus 14.

Upon receiving the service setting information request signal, the MTC server apparatus 15 transmits the previously stored service setting information to the MTC-GW unit 111 via the S/P-GW apparatus 14.

The data setting unit 1113 of the MTC-GW unit 111 performs a process of setting the received service setting information. Thereafter, the process proceeds to step S108.

(Step S108) The CPU 161 of the MTC terminal apparatus 16 generates the connection request signal including the previously set apparatus identifier and the MTC group identifier or the MTC service identifier. The CPU 161 of the MTC terminal apparatus 16 transmits the generated connection request signal to the base station apparatus 11. Thereafter, the process proceeds to step S109.

(Step S109) When the connection request signal received from the MTC terminal apparatus 16 includes the MTC group identifier or the MTC service identifier, the control unit 116 of the base station apparatus 11 outputs the received connection request signal to the MTC-GW unit 111. The apparatus determining unit 1114 of the MTC-GW unit 111 receives the connection request signal from the control unit 116 of the base station apparatus 11. The apparatus determining unit 1114 of the MTC-GW unit 111 extracts the apparatus identifier specifying the MTC terminal apparatus 16 and the MTC group identifier or the MTC service identifier from the received connection request signal.

The apparatus determining unit 1114 of the MTC-GW unit 111 reads the MTC service information or the MTC group information corresponding to the extracted MTC service identifier or the MTC group identifier from the MTC information storage unit 1115. The apparatus determining unit 1114 of the MTC-GW unit 111 extracts the transmission destination address information from the read MTC service information or the MTC group information.

The apparatus determining unit 1114 of the MTC-GW unit 111 outputs the extracted apparatus identifier and the transmission destination address information to the address managing unit 1116.

The address managing unit 1116 of the MTC-GW unit 111 generates different transmission source address information from all the transmission source address information stored in the address storage unit 1117. The address managing unit 1116 of the MTC-GW unit 111 stores the apparatus identifier input from the apparatus determining unit 1114, the generated transmission source address information, the input transmission destination address information, and the last reception time information at which the signal is lastly received from the MTC terminal apparatus 16 in the address storage unit 1117 in association with one another.

The address managing unit 1116 of the MTC-GW unit 111 generates the connection response signal including the generated transmission source address information, and transmits the generated connection response signal to the communication processing unit 163 of the MTC terminal apparatus 16.

The communication processing unit 163 of the MTC terminal apparatus 16 receives the connection response signal from the address managing unit 1116 of the MTC-GW unit 111, and extracts the transmission source address information from the received connection response signal. Thereafter, the process proceeds to step S110.

(Step S110) The communication processing unit 163 of the MTC terminal apparatus 16 generates the data packet including the generated data. The communication processing unit 163 includes the address information representing the MTC-GW unit 111 in the header of the data packet as the transmission destination address information. The communication processing unit 163 of the MTC terminal apparatus 16 transmits the transmission destination address information to the data transfer unit 1118 of the MTC-GW unit 111.

The data transfer unit 1118 of the MTC-GW unit 111 generates a new data packet in which the tunneling header is added to the data packet received from the communication processing unit 163 of the MTC terminal apparatus 16.

Here, the data transfer unit 1118 of the MTC-GW unit 111 reads the transmission destination address information corresponding to the transmission source address information included in the received data packet from the address storage unit 1118. The data transfer unit 1118 of the MTC-GW unit 111 replaces the transmission destination address information included in the received data packet with the read transmission destination address information.

The data transfer unit 1118 of the MTC-GW unit 111 generates the tunneling header including the address of the transmission source apparatus information and the address of the transmission destination apparatus information represented by the bearer information input from the registration processing unit 1111. The data transfer unit 1118 of the MTC-GW unit 111 generates a new data packet in which the tunneling header is added to the data packet in which the transmission destination address information is replaced.

Here, the data transfer unit 1118 of the MTC-GW unit 111 transmits the generated data packet to the S/P-GW apparatus 14.

The S/P-GW apparatus 14 removes the tunneling header from the data packet received from the data transfer unit 1118 of the MTC-GW unit 111, and outputs the data packet from which the tunneling header has been removed to the MTC server apparatus 15.

The MTC server apparatus 15 receives the data packet from the S/P-GW apparatus 14. Thereafter, the process ends.

As described above, according to the present embodiment, a communication path between the MTC-GW unit 11 and the S/P-GW 14 is secured for a certain MTC group or a certain MTC service. Further, the MTC terminal apparatus 16 transmits the connection request signal to the MTC-GW unit 111, and is allocated an address of its own apparatus, and data is transmitted and received between the MTC terminal apparatus 16 and the MTC server apparatus 15.

As a result, it is possible to prevent many MTC terminal apparatuses 16 from simultaneously transmitting the registration request signal to the MME before transmitting data, and thus the processing load of the MIME is reduced. Further, it is no longer necessary for the MTC terminal apparatus 16 to maintain a connection with a communication counterpart individually. Thus, an operation is performed only while data is transmitted and received and stops while data is not transmitted and received, and thus power consumption can be reduced.

### Second Embodiment

Next, a second embodiment of the present invention will be described with reference to the appended drawings.

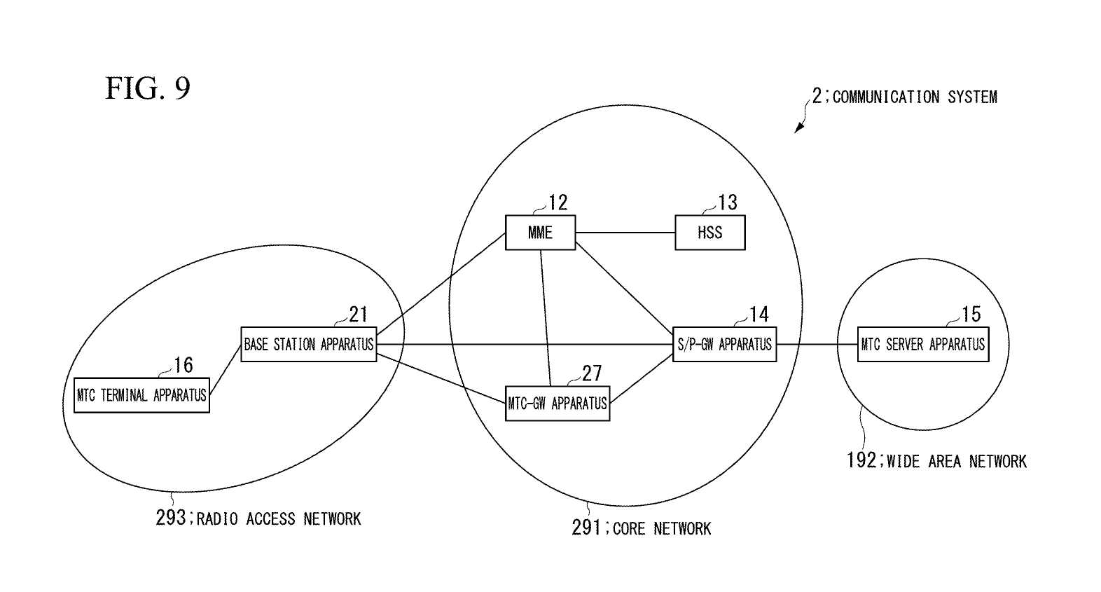

FIG. 9 is a schematic diagram illustrating a communication system 2 according to the present embodiment.

The communication system 2 is configured to include a base station apparatus 21, an MME 12, an HSS 13, an S/P-GW apparatus 14, an MTC server apparatus 15, an MTC terminal apparatus 16, an MTC-GW apparatus 27, a core network 291, a wide area network 192, and a radio access network 293.

The core network 291 is a network connecting the MME 12, the HSS 13, the S/P-GW apparatus 14, and the MTC-GW apparatus 27 with one another.

The radio access network 293 is a network that makes a wireless connection between the MTC terminal apparatus 16 and the base station apparatus 21.

In other words, the communication system 2 is a communication system in which in the communication system 1, the base station apparatus 21 and the MTC-GW apparatus 27 are distributedly arranged on the core network 291 instead of the base station apparatus 11. The following description will mainly focus on differences with the communication system 1. Any details not particularly mentioned here are the same as in the communication system 1.

Here, a constitution of the base station apparatus 21 according to the present embodiment will be described.

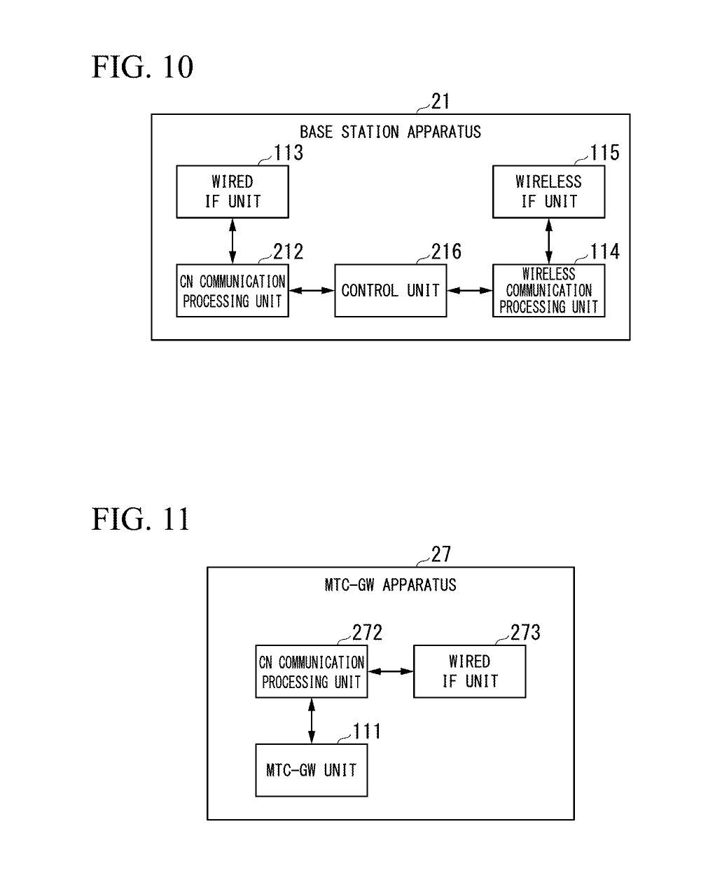

FIG. 10 is a schematic diagram illustrating a constitution of the base station apparatus 21 according to the present embodiment.

The base station apparatus 21 includes a CN communication processing unit 212, a wired IF unit 113, a wireless communication processing unit 114, a wireless IF unit 115, and a control unit 216. The base station apparatus 21 is different from the base station apparatus 11 in that the MTC-GW unit 111 is not provided.

The CN communication processing unit 212 converts a transmission signal whose transmission destination is the MTC-GW apparatus 27 among the transmission signals input from the control unit 216 into a certain format, and outputs the converted transmission signal to the wired IF unit 113.

The CN communication processing unit 212 converts a reception signal whose transmission source is the MTC-GW apparatus 27 among the reception signals input from the wired IF unit 113, and outputs the converted reception signal to the control unit 216. The remaining process is the same as in the CN communication processing unit 112.

The control unit 216 outputs a signal whose transmission destination is the MTC-GW apparatus 27 among the reception signals input from the wireless communication processing unit 114 to the CN communication processing unit 212 as the transmission signal.

The control unit 216 outputs a reception signal whose transmission source is the MTC-GW apparatus and whose transmission destination is the MTC terminal apparatus 16 among the reception signals input from the CN communication processing unit 212 to the wireless communication processing unit 114 as the transmission signal.

Upon receiving a normal terminal reception signal whose transmission source is the MTC-GW apparatus and whose final transmission destination is the control unit 216 among the reception signals input from the CN communication processing unit 212, the control unit 216 performs the same process as the control unit equipped in the base station apparatus 11 of the related art, similarly to the control unit 116. The remaining process is the same as in the control unit 116.

Next, a constitution of the MTC-GW apparatus 27 according to the present embodiment will be described.

FIG. 11 is a schematic diagram illustrating the MTC-GW apparatus 27 according to the present embodiment.

The MTC-GW apparatus 27 includes an MTC-GW unit 111, a CN communication processing unit 272, and a wired IF unit 273.

The MTC-GW unit 111 equipped in the MTC-GW apparatus 27 has the same constitution as the MTC-GW unit 111 equipped in the base station apparatus 11. Here, a difference lies in that, in the registration processing unit 1111, the data setting unit 1113, the apparatus determining unit 1114, the address managing unit 1116, and the data transfer unit 1118, a direct input/output destination of a signal is the CN communication processing unit 272. This difference is due to the MTC-GW apparatus 27 being connected to the core network 291. Further, the apparatus determining unit 1114 of the MTC-GW apparatus 27 outputs the generated normal terminal signal to the CN communication processing unit 272 as the transmission signal to be transmitted to the control unit 116 of the base station apparatus 21.

The CN communication processing unit 272 converts the transmission signal input from the MTC-GW unit 111 into a certain format, and outputs the converted transmission signal to the wired IF unit 273.

The CN communication processing unit 272 converts the reception signal input from the wired IF unit 273 into a certain format, and outputs the converted reception signal to the MTC-GW unit 111.

The wired IF unit 273 transmits the transmission signal input from the CN communication processing unit 272 to an apparatus connected to a corresponding network via the core network 291. The wired IF unit 273 receives the reception signal from an apparatus connected to the core network 291 via a corresponding network. The wired IF unit 273 outputs the received reception signal to the CN communication processing unit 272.

Next, a communication process performed by the communication system 2 according to the present embodiment will be described.

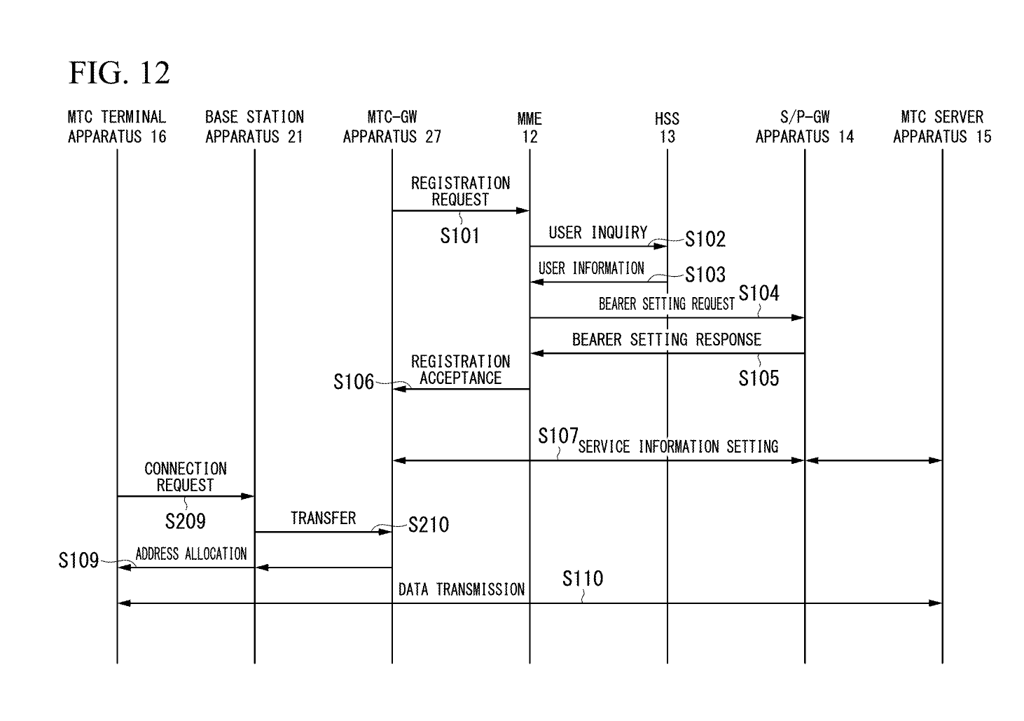

FIG. 12 is a sequence diagram illustrating a communication process performed by the communication system 2 according to the present embodiment. The communication process illustrated in FIG. 12 differs from the communication process illustrated in FIG. 8 in that steps S209 and S210 are performed instead of step S108. Further, a difference lies in that, in steps S101, S106, and S107 of FIG. 12, the process performed by the MTC-GW unit 111 in FIG. 8 is performed by the MTC-GW apparatus 37. In the other points, the communication process illustrated in FIG. 12 is the same as the communication process illustrated in FIG. 8.

(Step S209) The CPU 161 of the MTC terminal apparatus 16 generates the connection request signal including the previously set apparatus identifier and the MTC group identifier or the MTC service identifier. The CPU 161 of the MTC terminal apparatus 16 transmits the generated connection request signal to the control unit 216 of the base station apparatus 21 as a relay destination. Here, the final transmission destination is the apparatus determining unit 1114 of the MTC-GW unit 111 equipped in the MTC-GW apparatus 27. The control unit 216 of the base station apparatus 21 receives the connection request signal from the CPU 161 of the MTC terminal apparatus 16. Thereafter, the process proceeds to step S210.

(Step S210) The control unit 216 of the base station apparatus 21 transfers the received connection request signal to the apparatus determining unit 1114 of the MTC-GW unit 111 equipped in the MTC-GW apparatus 27. Thereafter, the process proceeds to step S110.

As a result, according to the present embodiment, even when the MTC-GW unit 111 is separated from the base station apparatus 21 simultaneous transmission of the registration request signal to the MME 12 by many MTC terminal apparatuses 16 before transmission of data is avoided. Thus, the processing load of the MME is reduced. Similarly, the power consumption of the MTC-GW terminal apparatus 16 is reduced.

### Third Embodiment

Next, a third embodiment of the present invention will be described with reference to the appended drawings.

In the present embodiment, it is determined whether a communication apparatus that has transmitted the connection request signal representing the connection request is an MTC terminal apparatus related to a certain MTC group or MTC service. Further, in the present embodiment, an MTC-GW apparatus related to another group or service corresponding to the corresponding MTC group or MTC service is decided.

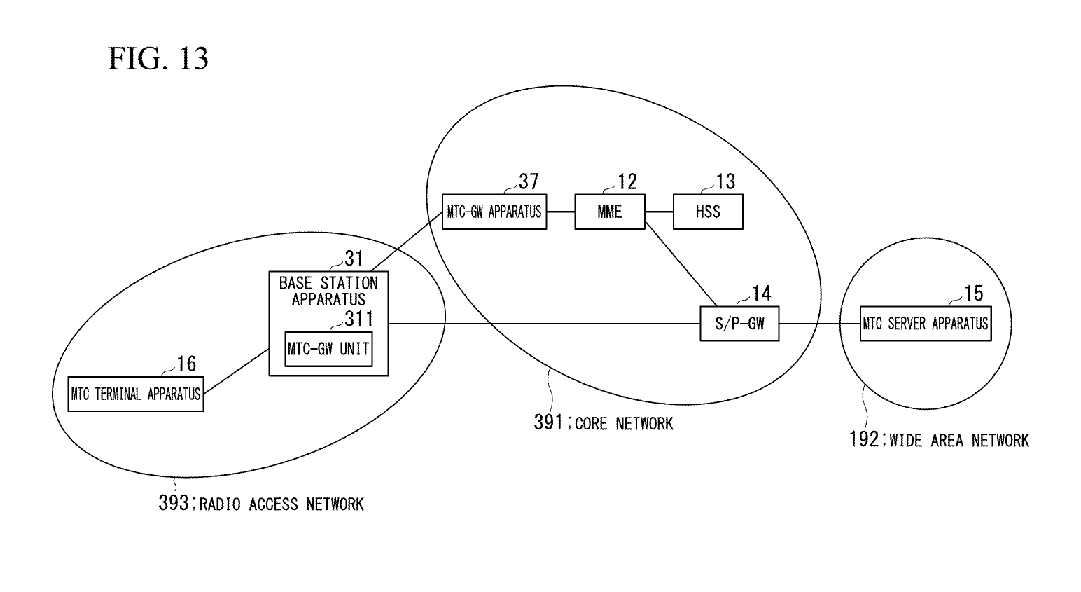

FIG. 13 is a schematic diagram illustrating a communication system 3 according to the present embodiment.

The communication system 3 is configured to include a base station apparatus 31, an MME 12, an HSS 13, an S/P-GW apparatus 14, an MTC server apparatus 15, an MTC terminal apparatus 16, an MTC-GW apparatus 37, a core network 391, a wide area network 192, and a radio access network 393.

The core network 391 is a network connecting the MME 12, the HSS 13, the S/P-GW apparatus 14, and the MTC-GW apparatus 37 with one another.

The wide area network 192 is a network configured to include the MTC server apparatus 15.

The radio access network 293 is a network connecting the MTC terminal apparatus 16 and the base station apparatus 31.

In other words, the communication system 3 is a communication system in which in the communication system 1, and the base station apparatus 31 including the MTC-GW unit 311 and the MTC-GW apparatus 37 are hierarchically arranged instead of the base station apparatus 11 including the MTC-GW unit 111. The following description will mainly focus on differences with the communication system 1. Any details not particularly mentioned here are the same as in the communication system 1.

The base station apparatus 31 includes the MTC-GW unit 311 instead of the MTC-GW unit 111 in the base station apparatus 11. The constitution other than the MTC-GW unit 311 of the base station apparatus 31 is similar to the base station apparatus 11. Here, a constitution of the MTC-GW unit 311 will be described.

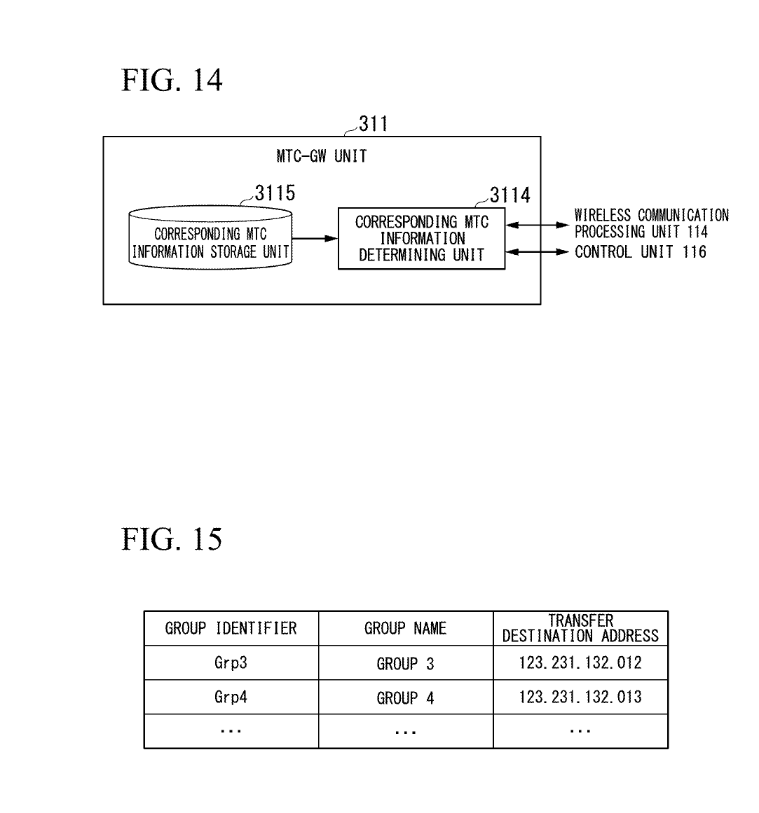

FIG. 14 is a schematic diagram illustrating a constitution of the MTC-GW unit 311 according to the present embodiment.

The MTC-GW unit 311 is configured to include a corresponding MTC information determining unit 3114 and a corresponding MTC information storage unit 3115 in addition to the same constitution as the MTC-GW unit 111. Through this constitution, the MTC-GW unit 311 can relay the connection request signal to the MTC-GW 37 for a certain MTC group or MTC service.

The corresponding MTC information determining unit 3114 receives the reception signal from the wireless communication processing unit 114 as the connection request signal received from the MTC terminal apparatus 16. The corresponding MTC information determining unit 3114 extracts the apparatus identifier specifying the MTC terminal apparatus 16 and the MTC group identifier or the MTC service identifier from the received connection request signal.

The corresponding MTC information determining unit 3114 reads MTC correspondence group information or MTC correspondence service information corresponding to the extracted MTC group identifier or the MTC service identifier from the corresponding MTC information storage unit 3115. The corresponding MTC group information or the corresponding MTC service information may be stored in the corresponding MTC information storage unit 3115. The corresponding MTC group information is information in which the MTC group identifier, the group name information, and transfer destination address information are associated with one another. The transfer destination address information is an address apparatus of an MTC server apparatus that performs processing on a corresponding MTC group associated with an MTC group represented by the MTC group identifier. The MTC server apparatus is the MTC server apparatus 37 in the example illustrated in FIG. 13. The corresponding MTC service information is information in which the MTC service identifier, the service name information, and the transfer destination address information are associated with one another. The transfer destination address information is an address apparatus of an MTC server apparatus that processes a corresponding MTC service associated with an MTC service represented by the MTC service identifier.

When the corresponding MTC service information or the corresponding MTC group information is successfully read, the corresponding MTC information determining unit 3114 extracts the transfer destination address information from the read information.

The corresponding MTC information determining unit 3114 outputs the connection request signal to the CN communication processing unit 112 as the transmission signal to be transmitted to the transfer destination apparatus represented by the transfer destination address information.

When the corresponding MTC information determining unit 3114 fails to read the corresponding MTC service information or the corresponding MTC group information, it generates the normal terminal signal representing that the transmission source apparatus of the registration request signal is a normal terminal apparatus. The corresponding MTC information determining unit 3114 outputs the generated normal terminal signal to the control unit 116.

Next, the corresponding MTC group information according to the present embodiment will be described.

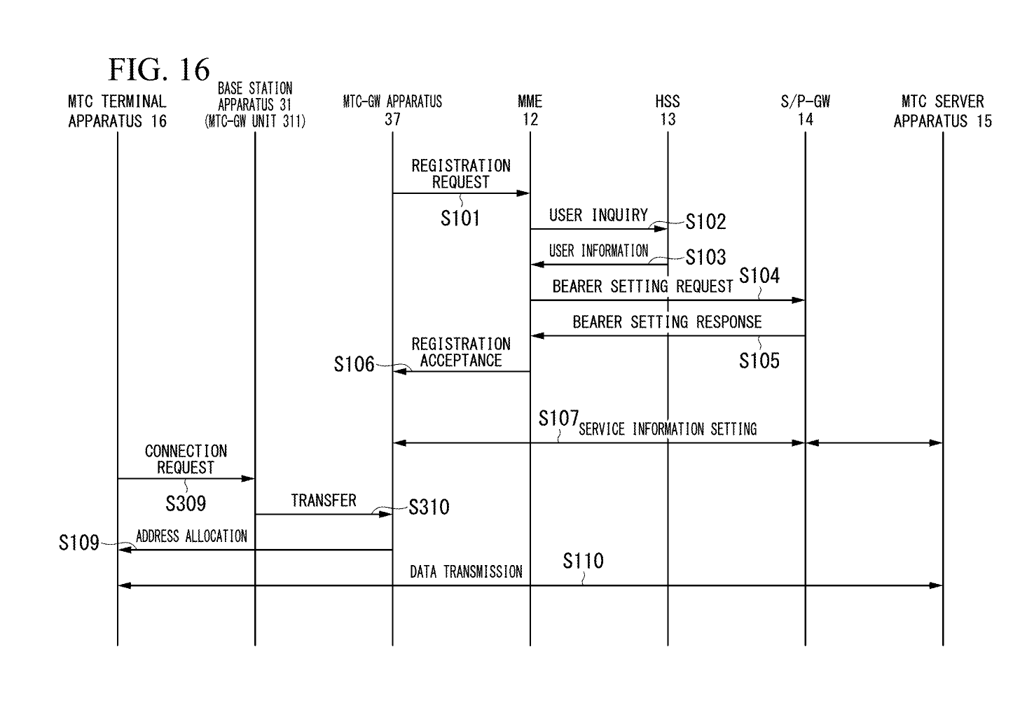

FIG. 15 is a diagram illustrating exemplary corresponding MTC group information according to the present embodiment.

FIG. 15 illustrates the group identifier, the group name information and the transfer destination address information in order from the leftmost end to the right side. In FIG. 15, in a second row from an uppermost row, a group 3 is shown as the group name information corresponding to a group identifier Grp3, and 123.231.132.012 is shown as the transfer destination address information. In FIG. 15, in a third row from the uppermost row, a group 4 is shown as the group name information corresponding to a group identifier Grp4, and 123.231.132.013 is shown as the transfer destination address information.

Further, the corresponding MTC service information is also similarly configured.

The MTC-GW apparatus 37 is configured to include the MTC-GW unit 111, the CN communication processing unit 272, and the wired IF unit 273, similarly to the MTC-GW apparatus 27 illustrated in FIG. 11.

The MTC information storage unit 1115 of the MTC-GW apparatus 37 stores either the MTC service information or the MTC group information. The MTC service information is MTC service information associated with a service related to the corresponding MTC service information. The MTC group information is MTC group information associated with a group related to the corresponding MTC group information.

The reception signal is input to the apparatus determining unit 1114 of the MTC-GW apparatus 37 from the wireless communication processing unit 114 as the connection request signal received from the apparatus determining unit 1114 of the MTC-GW unit 111. The apparatus determining unit 1114 of the MTC-GW apparatus 37 may omit the process of extracting the MTC group identifier or the MTC service identifier from the received connection request signal. The apparatus determining unit 1114 of the MTC-GW apparatus 37 outputs the apparatus identifier extracted from the connection request signal to the address managing unit 1116.

Next, a communication process performed by the communication system 3 according to the present embodiment will be described.

FIG. 16 is a sequence diagram illustrating a communication process performed by the communication system 3 according to the present embodiment. The communication process illustrated in FIG. 16 differs from the communication process illustrated in FIG. 8 in that steps step S309 to S311 are performed instead of steps S108 to S110. Further, a difference lies in that, in steps S101, S106 to S108 of FIG. 16, the process performed by the MTC-GW unit 111 in FIG. 8 is performed by the MTC-GW apparatus 37. In the other points, the communication process illustrated in FIG. 16 is the same as the communication process illustrated in FIG. 8.

(Step S309) The CPU 161 of the MTC terminal apparatus 16 generates the connection request signal including the previously set apparatus identifier and the MTC group identifier or the MTC service identifier. The CPU 161 of the MTC terminal apparatus 16 transmits the generated connection request signal to the corresponding MTC information determining unit 3114 of the MTC-GW unit 311. Thereafter, the process proceeds to step S310.

(Step S310) The corresponding MTC information determining unit 3114 of the MTC-GW unit 311 receives the connection request signal from the CPU 161 of the MTC terminal apparatus 16. The corresponding MTC information determining unit 3114 of the MTC-GW unit 311 extracts the apparatus identifier specifying the MTC terminal apparatus 16 and the MTC group identifier or the MTC service identifier from the received connection request signal.

The corresponding MTC information determining unit 3114 of the MTC-GW unit 311 reads the transfer destination address information corresponding to the extracted MTC service identifier or the MTC group identifier from the corresponding MTC information storage unit 3115. The corresponding MTC information determining unit 3114 of the MTC-GW unit 311 transmits the received connection request signal to the apparatus determining unit 1114 of the MTC-GW apparatus 37 represented by the transfer destination address information.

The apparatus determining unit 1114 of the MTC-GW apparatus 37 extracts the apparatus identifier from the connection request signal received from the corresponding MTC information determining unit 3114 of the MTC-GW unit 311. The apparatus determining unit 1114 of the MTC-GW apparatus 37 reads the MTC service information or the MTC group information, and extracts the transmission destination address information from read MTC service information or the MTC group information. The apparatus determining unit 1114 of the MTC-GW apparatus 37 outputs the extracted apparatus identifier and the transmission destination address information to the address managing unit 1116.

The address managing unit 1116 of the MTC-GW apparatus 37 generates address information different from all address information stored in the address storage unit 1117. The address managing unit 1116 of the MTC-GW apparatus 37 stores the apparatus identifier input from the apparatus determining unit 1114, the generated address information, the transmission destination address information input from the apparatus determining unit 1114, and the last reception time information at which the signal is lastly received from the MTC-GW unit 311 in the address storage unit 1117 in association with one another.

The address managing unit 1116 of the MTC-GW apparatus 37 generates the connection response signal including the generated transmission source address information, and transmits the generated connection response signal to the communication processing unit 163 of the MTC terminal apparatus 16.

The communication processing unit 163 of the MTC terminal apparatus 16 receives the connection response signal from the address managing unit 1116 of the MTC-GW apparatus 37, and extracts the transmission source address information from the received connection response signal. Thereafter, the process proceeds to step S311.

(Step S311) The communication processing unit 163 of the MTC terminal apparatus 16 generates a data packet including the generated data. The communication processing unit 163 includes address information representing the MTC-GW apparatus 37 in the header of the data packet as the transmission destination address information. The communication processing unit 163 of the MTC terminal apparatus 16 transmits the transmission destination address information to the data transfer unit 1118 of the MTC-GW apparatus 37.

The data transfer unit 1118 of the MTC-GW apparatus 37 generates a new data packet in which the tunneling header is added to the data packet received from the communication processing unit 163 of the MTC terminal apparatus 16. The data transfer unit 1118 of the MTC-GW unit 311 reads the transmission destination address information corresponding to the transmission source address information included in the received data packet from the address storage unit 1118. The data transfer unit 1118 of the MTC-GW unit 311 replaces the transmission destination address information included in the received data packet with the read transmission destination address information.

The data transfer unit 1118 of the MTC-GW unit 311 generates the tunneling header including the address of the transmission source apparatus information and the address of the transmission destination apparatus information represented by the bearer information input from the registration processing unit 1111. The data transfer unit 1118 of the MTC-GW unit 111 generates a new data packet in which the tunneling header is added to the data packet in which the transmission destination address information is replaced.

Here, the data transfer unit 1118 of the MTC-GW unit 111 transmits the generated data packet to the S/P-GW apparatus 14.

The S/P-GW apparatus 14 removes the tunneling header from the data packet received from the data transfer unit 1118 of the MTC-GW unit 311, and outputs the data packet from which the tunneling header has been removed to the MTC server apparatus 15.

The MTC server apparatus 15 receives the data packet from the S/P-GW apparatus 14. Thereafter, the process ends. As a result, tunneling is performed between the MTC-GW apparatus 37 and the S/P-GW apparatus 14, and data is transmitted and received between the MTC terminal apparatus 16 and the MTC server apparatus 15.

As described above, in the present embodiment, it is determined whether a communication apparatus that has transmitted the connection request signal is the MTC terminal apparatus 16 related to a certain group or service, and the connection request signal is transferred to the MTC-GW apparatus 37 corresponding to the group or service. Thus, according to the present embodiment, it is possible to reduce the load of the MME, and it is possible to perform MTC related to the MTC service or the MTC group associated with a certain MTC service or MTC group.

### Fourth embodiment

Next, a fourth embodiment of the present invention will be described with reference to the appended drawings.

A communication system 4 according to the present embodiment is a communication system including a relay node (RN) apparatus 48, a base station apparatus 41 that transfers data received from the RN apparatus 48, an S/P-GW apparatus 14 that transmits data received from the base station apparatus 41 to the MTC server apparatus 15, and an MME 12 that performs a process of setting a communication path between the RN apparatus 48 and the S/P-GW apparatus 14. Here, the RN apparatus 48 transmits the registration request signal to the MME 12, establishes the communication path with the S/P-GW apparatus 14 after the MME 12 sets the communication path, and transfers data received from the MTC terminal apparatus to the S/P-GW apparatus 14.

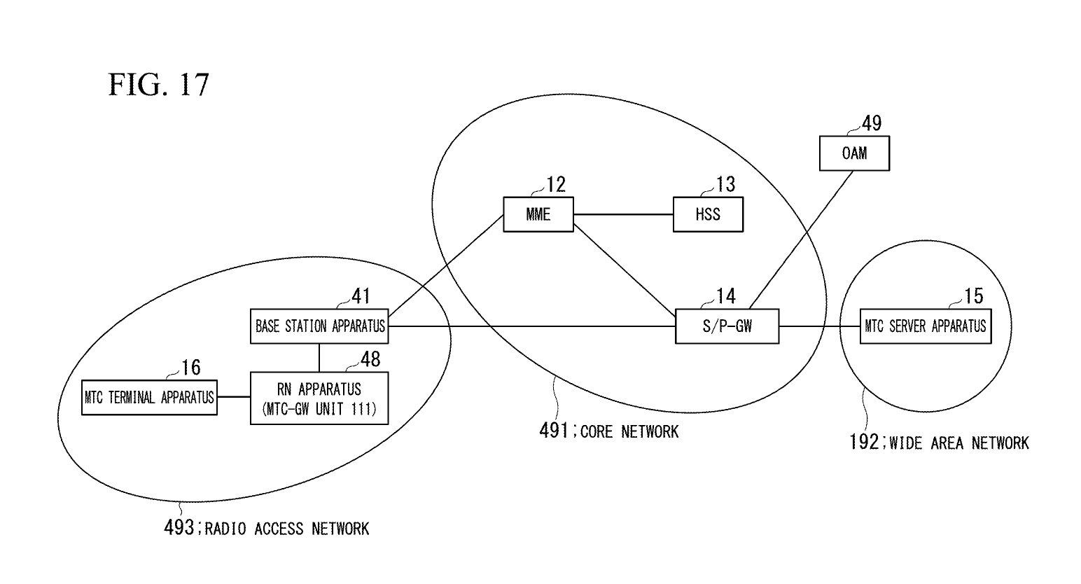

FIG. 17 is a schematic diagram illustrating the communication system 4 according to the present embodiment.

The communication system 4 is configured to include the base station apparatus 41, the MME 12, the HSS 13, the S/P-GW apparatus 14, the MTC server apparatus 15, the MTC terminal apparatus 16, the RN apparatus 48, an operation and maintenance server (OAM) 49, a core network 491, a wide area network 192, and a radio access network 493.

The core network 491 is a network connecting the base station apparatus 41, the MME 12, the HSS 13, and the S/P-GW apparatus 14 with one another.

The radio access network 493 is a network connecting the MTC terminal apparatus 16, the base station apparatus 21, and the RN apparatus 48 with one another.

In other words, the communication system 4 is a communication system in which in the communication system 1, the base station apparatus 41 not including the MTC-GW unit 111 and the RN apparatus 48 including the MTC-GW unit 111 are arranged in the radio access network 493 instead of the base station apparatus 11 including the MTC-GW unit ill. The following description will mainly focus on differences with the communication system 1. Any details not particularly described here are the same as in the communication system 1.

The base station apparatus 41 is a base station apparatus that performs wireless communication with the RN apparatus 48 or the MTC terminal apparatus 16 through the RN apparatus 48. For example, the base station apparatus 41 is a donor base station apparatus (DeNB).

The base station apparatus 41 generates a connection response signal representing that communication is possible when a connection request signal representing that the transmission source apparatus (the RN apparatus 48 in FIG. 17) requests a connection (for example, an RRC connection) is received. The base station apparatus 41 transmits the generated connection response signal to the transmission source apparatus.

The base station apparatus 41 transmits a signal which is received from the RN apparatus 48 to be directed to the transmission destination apparatus (the MME 12 and the S/P-GW apparatus 14 in the example of FIG. 17) to the transmission destination apparatus.

Next, a constitution of the RN apparatus 48 will be described.

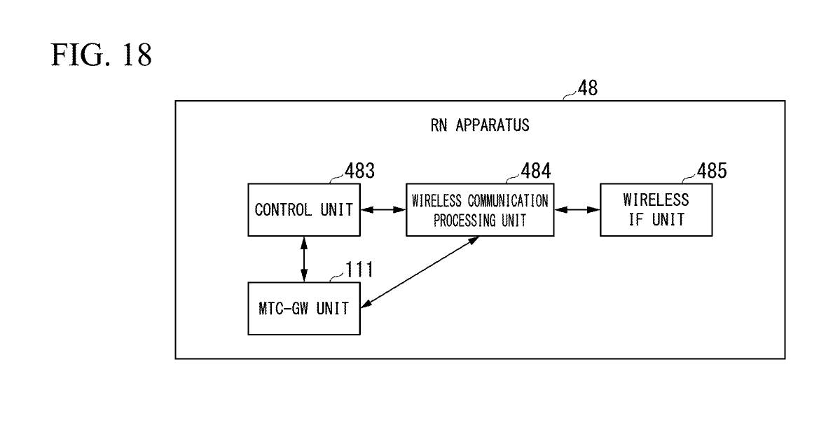

FIG. 18 is a schematic diagram illustrating a constitution of the RN apparatus 48 according to the present embodiment.

The RN apparatus 48 is configured to include an MTC-GW unit 111, a control unit 483, a wireless communication processing unit 484, and a wireless IF unit 485.

The MTC-GW unit 111 equipped in the RN apparatus 48 has the same constitution as the MTC-GW unit 111 equipped in the base station apparatus 11. Here, a difference lies in that, in the registration processing unit 1111, the data setting unit 1113, the apparatus determining unit 1114, the address managing unit 1116, and the data transfer unit 1118, a direct input/output destination of a signal is the wireless communication processing unit 484. This difference is due to the RN apparatus 48 being connected to the radio access network 493. Further, the apparatus determining unit 1114 of the RN apparatus 48 outputs the generated normal terminal signal to the wireless communication processing unit 484 as the transmission signal to be transmitted to the control unit 116 of the base station apparatus 41.

The control unit 483 generates the connection request signal in advance, and outputs the generated connection request signal to the wireless communication processing unit 484 as the transmission signal to be transmitted to the base station apparatus 41. The connection response signal received from the base station apparatus 41 is input to the control unit 483 from the wireless communication processing unit 484. As a result, a connection (for example, an RRC connection) is established between the RN apparatus 48 and the base station apparatus 41. Here, when a period of time until the connection response signal is received after the communication request signal is transmitted exceeds a previously set period of time (for example, 90 seconds), the control unit 483 determines that a connection has failed to be established, and stops the process.

Further, when the MTC apparatus identifier, the MTC group information, or the MTC service information is included in the connection request signal serving as the reception signal input from the wireless communication processing unit 484, the control unit 483 outputs the input connection request signal to the MTC-GW unit 111. This operation causes the MTC-GW unit 111 to start the process related to the connection request from the MTC terminal apparatus 16.

The wireless communication processing unit 484 converts the transmission signal input from the MTC-GW unit 111 or the control unit 483 into the transmission signal of the radio frequency band, and outputs the converted transmission signal of the radio frequency band to the wireless IF unit 485. The wireless communication processing unit 484 converts the reception signal of the radio frequency band input from the wireless IF unit 485 into the reception signal of the base frequency band, and outputs the converted reception signal to the MTC-GW unit 111 or the control unit 483.

The wireless IF unit 485 is an interface for wirelessly transmitting and receiving a signal with the radio access network 193. The wireless IF unit 485 transmits the transmission signal input from the wireless communication processing unit 483 to an apparatus (the MTC terminal apparatus 16 or the base station apparatus 41 in the example of FIG. 17) connected to a corresponding network via the radio access network 493. The wireless IF unit 485 receives the reception signal from an apparatus connected to the radio access network 193 via a corresponding network. The wireless IF unit 485 outputs the received reception signal to the wireless communication processing unit 484.

The OAM 49 sets a setting parameter of the RN apparatus 48 or the base station apparatus. For example, the setting parameter information is an initial setting parameter (for example, a cell ID, a frequency, a bandwidth, or the like) related to an operation of the RN apparatus 48. All the parameters relate to an operation of the RN apparatus 48 and decided by the OAM 49 based on the surrounding environment of the RN apparatus 48.

When an initial setting parameter request signal is received from the RN apparatus 48, the OAM 49 transmits the initial setting parameter information to the RN apparatus 48. The initial setting parameter request signal is a signal representing that the initial setting parameter information is requested.

The OAM 49 is connected to the S/P-GW 14 but does not belong to the core network 491.

Next, a communication process performed by the communication system 4 according to the present embodiment will be described.

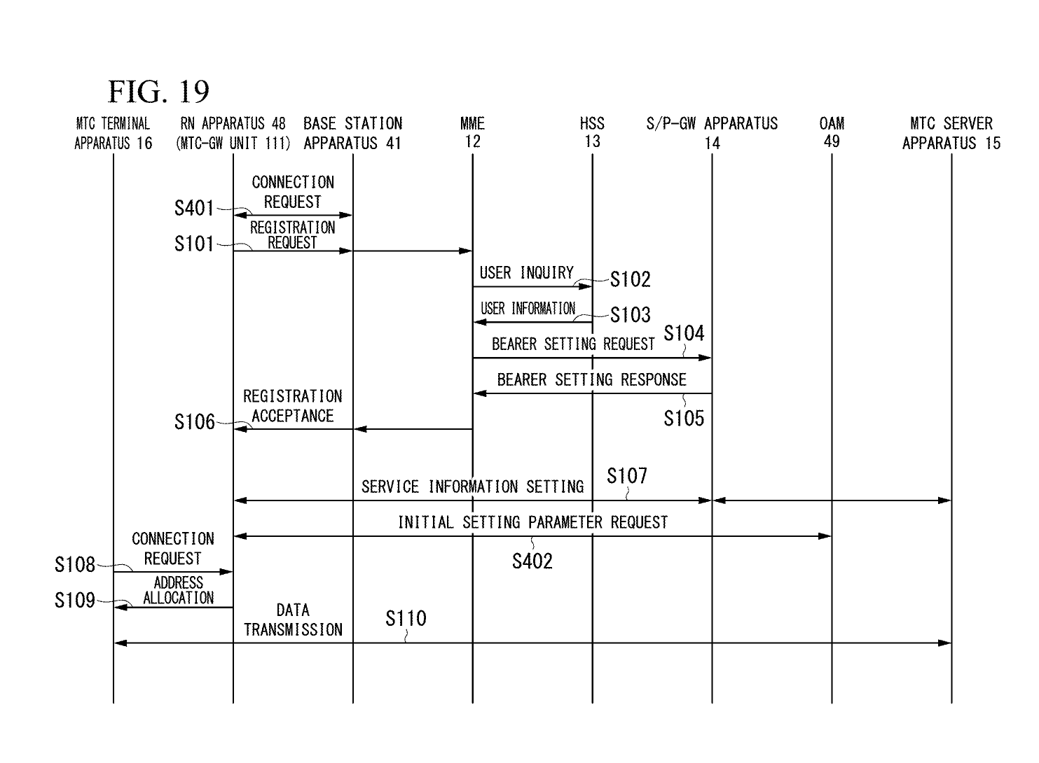

FIG. 19 is a sequence diagram illustrating a communication process performed by the communication system 4 according to the present embodiment. The communication process illustrated in FIG. 19 differs from the communication process illustrated in FIG. 8 in that step S401 is performed before step S101. A difference lies in that, in steps S101, S106, and S107 of FIG. 19, the process performed by the MTC-GW unit 111 of the base station apparatus 11 in FIG. 8 is performed by the MTC-GW unit 111 of the RN apparatus 48, and the transmission and reception signals pass through the base station apparatus 41. After step S107, the RN apparatus 48 performs step S402.

Further, step S402 may be performed in parallel with the process (MTC-GW registration) of steps S101 to S106 or the process (a service information setting) of step S107.

A difference lies in that, in steps S109 and S110 of FIG. 19, the process performed by the MTC-GW unit 111 of the base station apparatus 11 in FIG. 8 is performed by the MTC-GW unit 111 of the RN apparatus 48.

In the other points, the communication process illustrated in FIG. 16 is similar to the communication process illustrated in FIG. 8.

(Step S401) The control unit 483 of the RN apparatus 48 generates the connection request signal in advance, and transmits the generated connection request signal to the base station apparatus 41.

When the connection request signal is received from the control unit 483 of the RN apparatus 48, the base station apparatus 41 generates the connection response signal representing that communication is possible. The base station apparatus 41 transmits the generated connection response signal to the control unit 483 of the RN apparatus 48.

The control unit 483 of the RN apparatus 48 receives the connection response signal received from the base station apparatus 41. Thereafter, the process proceeds to step S101.

(Step S402) The RN apparatus 48 generates the initial setting parameter request signal, and transmits the generated initial setting parameter request signal to the OAM 49. The OAM 49 receives the initial setting parameter request signal from the RN apparatus 48, and transmits the initial setting parameter information to the RN apparatus 48. Thereafter, the process proceeds to step S109.

As the communication process according to the present embodiment is performed, tunneling of a data signal is performed between the RN apparatus 48 and the SIP-GW apparatus 14, and data is transmitted and received between the MTC terminal apparatus 16 and the MTC server apparatus 15.

According to the present embodiment, even when the MTC-GW unit 111 is equipped in the RN apparatus 48, simultaneous transmission of the registration request signal to the MME 12 by many MTC terminal apparatuses 16 is avoided. Thus, the processing load of the MME 12 is reduced. At the same time, the power consumption of the MTC terminal apparatus 16 can be reduced.

Further, when the number of the MTC terminal apparatuses 16 present or a communication capability according to transmission and reception is larger than a certain value, the control unit 483 of the RN apparatus 48 may reduce the number of normal terminal apparatuses to be accommodated or increase the number of MTC terminal apparatuses. In this case, the control unit 483 may set a service quality lower than an initial value to the normal terminal apparatuses and increase the number of MTC terminal apparatuses to be accommodated. Further, the control unit 483 may respond to the connection request signals transmitted from the MTC terminal apparatuses 16 without responding to the connection request signals transmitted from the normal terminal apparatuses. As described above, the RN apparatus 48 gives a priority to communication requested from the MTC terminal apparatuses 16. Here, the number of the MTC terminal apparatuses 16 present is counted by counting the connection request signals received from the MTC terminal apparatuses 16 and subtracting the number of the MTC terminal apparatuses 16 that have terminated a connection. The control unit 483 calculates a transmission amount of each MTC terminal apparatus in a service or group corresponding to the MTC service identifier or the MTC group identifier represented by the received connection request signal among the MTC terminal apparatuses 16 present.

Further, the RN apparatus 48 has the same constitution as the MTC terminal apparatus 16, and may transmit user data that it has acquired to the MTC server apparatuses 15 belonging to the same MTC service or the same MTC group. Here, the RN apparatus 48 may receive the connection request signal from another MTC terminal apparatus 16 and perform processing on the received connection request signal as described above.

### Fifth Embodiment

Next, a fifth embodiment of the present invention will be described with reference to the appended drawings.

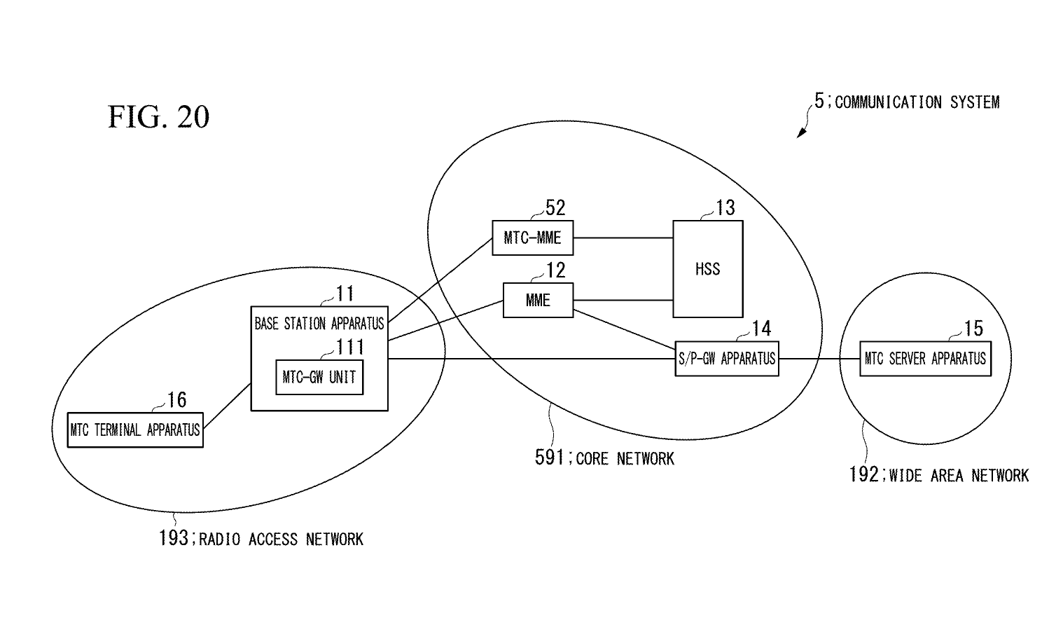

FIG. 20 is a conceptual diagram illustrating a constitution of a communication system 5 according to the present embodiment.

The communication system 5 is configured to include a base station apparatus 11, an MME 12, an HSS 13, an S/P-GW apparatus 14, an MTC server apparatus 15, an MTC terminal apparatus 16, an MTC-MME 52, a core network 591, a wide area network 192, and a radio access network 193.

The core network 591 includes the MME 12, the HSS 13, the S/P-GW apparatus 14, and the MTC-MME 52.

In other words, the communication system 5 is a communication system in which the MTC-MME 52 is equipped in the radio access network 493 in the communication system 1. The following description will mainly focus on differences with the communication system 1. Any details not particularly described here are the same as in the communication system 1.

The MTC-MME 52 is an MME related to a certain MTC service or MTC group. The MTC-MME 52 has the same constitution as a normal MME 12. Here, the MTC-MME 52 receives the registration request signal from the MTC terminal apparatus 16 through the base station apparatus 11. A timing at which the MTC terminal apparatus 16 transmits the registration request signal is not limited to when the MTC terminal apparatus 16 initially starts transmission and reception of data related to the MTC service or the MTC group. For example, there are cases in which the MTC terminal apparatus 16 enters a registration region (Tracking Area) of the MTC-MME 52. The registration region is a region in which the MTC-MME 52 (or the MME 12) can receive the registration request signal so that the terminal apparatus including the MTC terminal apparatus 16 perform communication. The registration region is usually a region including one or more cells which are regions in which the base station apparatus 11 can perform transmission and reception of data with the terminal apparatus. Further, the MTC terminal apparatus 16 receives the registration acceptance signal from the MTC-MME 52 and then transmits a deregistration signal representing deregistration from another MTC-MME.

The MTC-MME 52 includes a storage unit storing the MTC service information or the MTC group information.

The MTC-MME 52 extracts the MTC service identifier or the MTC group identifier from the received registration request signal. The MTC-MME 52 reads the transmission destination address information corresponding to the extracted MTC service identifier or the MTC group identifier from the storage unit.

The MTC-MME 52 generates the registration acceptance signal including the read transmission destination address information, and transmits the generated registration acceptance signal to the MTC terminal apparatus 16. Further, when the registration failure signal is generated, the MTC-MME 52 transmits the generated registration failure signal to the MTC terminal apparatus 16.

The remaining process performed by the MTC-MME 52 is the same as in the MME 12.

Next, a communication process performed by the communication system 5 according to the present embodiment will be described.

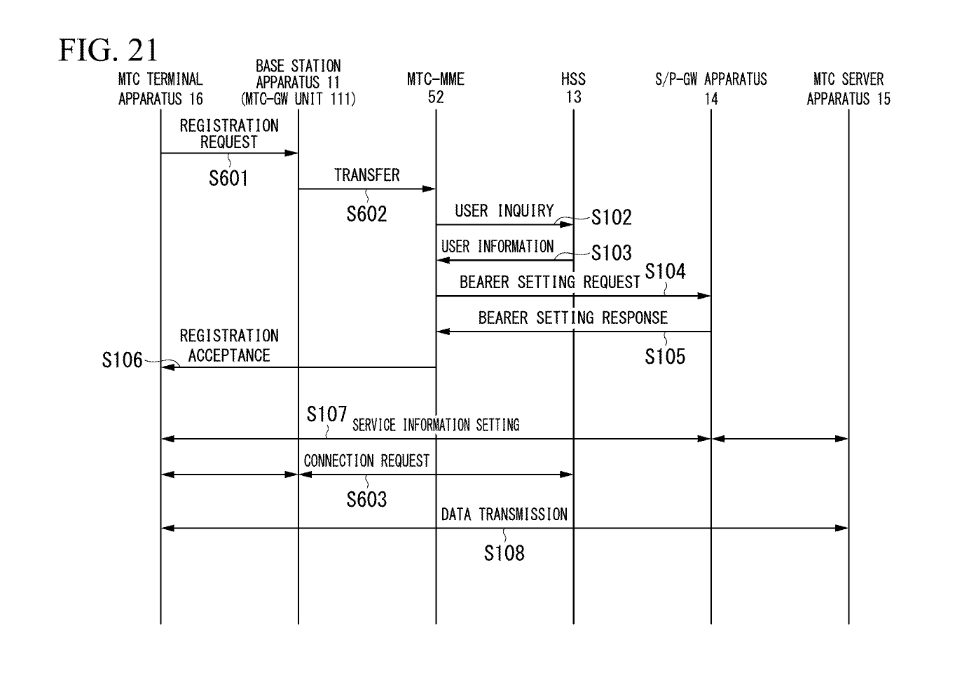

FIG. 21 is a sequence diagram illustrating a communication process performed by the communication system 5 according to the present embodiment. In FIG. 21, after steps S601 and S602 are performed, the process corresponding to steps S102 to S106 of FIG. 8 is performed. Here, steps S102 to S106 are performed by the MTC-MME 52 instead of the MME 12. Further, after step S106 the MTC terminal apparatus 16 performs step S603 and then performs step S108.

In the other points, the communication process illustrated in FIG. 21 is the same as the communication process illustrated in FIG. 8.

(Step S601) The CPU 161 of the MTC terminal apparatus 16 reads the apparatus identifier and the MTC group identifier or the MTC service identifier. The CPU 161 of the MTC terminal apparatus 16 generates the registration request signal including the read apparatus identifier and the MTC group identifier or the MTC service identifier. The CPU 161 of the MTC terminal apparatus 16 transmits the generated registration request signal to the control unit 116 of the base station apparatus 11. Thereafter, the process proceeds to step S602.

(Step S602) The control unit 116 of the base station apparatus transmits the registration request signal read from the CPU 161 of the MTC terminal apparatus 16 to the MTC-MME 52. Thereafter, the process proceeds to step S102.

(Step S603) The CPU 161 of the MTC terminal apparatus 16 generates the connection request signal for requesting a connection with the S/P-GW apparatus 14, and transmits the generated connection request signal to the S/P-GW apparatus 14 through the base station apparatus 11.

The S/P-GW apparatus 14 receives the connection request signal, and generates the connection response signal representing that communication is possible. The S/P-GW apparatus 14 transmits the generated connection response signal to the MTC terminal apparatus 16 through the base station apparatus 11.

The CPU 161 of the MTC terminal apparatus 16 receives the connection response signal from the S/P-GW apparatus 14. Thereafter, the process proceeds to step S108.

As the communication process according to the present embodiment is performed, even when the MTC terminal apparatus 16 moves across the registration region, data related to a certain MTC service or MTC group is transmitted and received between the MTC terminal apparatus 16 and the MTC server apparatus 15.

According to the present embodiment, the MTC-MME 52 receives the registration request signal transmitted by the MTC terminal apparatus 16, and a connection is established between the MTC terminal apparatus 16 and the S/P-GW apparatus 14. Thus, the processing load of the MME is reduced. Further, when a wireless communication network is configured, and each core network includes at least one MTC-MME in a region in which a certain service is provided, transmission and reception of data related to the MTC service or the MTC group can be implemented across the core network. Thus, the MTC service of the broad area is provided.

The above embodiment has been described in connection with the example in which the transmission destination apparatus is the MTC server apparatus 15 connected to the S/P-GW apparatus 14 and the wide area network 193, but the present invention is not limited to this example. In the above embodiment, the transmission destination apparatus may be an apparatus that is represented by the transmission destination address information in the MTC service information or the MTC group information and capable of establishing a connection with the S/P-GW apparatus 14. For example, the transmission destination apparatus may be an MTC user apparatus which is connected to be relayed by the MTC server apparatus 15. Furthermore, the transmission destination apparatus may be the MTC terminal apparatus 16 that is connectable to an MTC-GW apparatus connected to another core network. Further, in the above embodiment, the number of transmission destination apparatuses is not limited to 1, and may be an arbitrary number of two or more.

In the above embodiment, in the present embodiment, regardless of whether the MTC-GW unit 31 is configured to serve as a part of the base station apparatus 31, the connection request signal may be relayed to the MTC-GW apparatus 37 related to a certain MTC service or MTC group. For example, the MTC-GW apparatus 27 and the MTC-GW unit 111 of the RN apparatus 48 may have the same constitution as the MTC-GW unit 31 of the base station apparatus 31.

The above embodiment has been described in connection with the example in which the MTC server apparatus 37 that performs processing on one corresponding MTC service corresponding to the MTC service identifier or one corresponding MTC group associated with the MTC group identifier is provided, but the present invention is not limited to this example. In the above embodiment, the MTC server apparatus 37 that performs processing on a plurality of corresponding MTC services corresponding to the MTC service identifier or a plurality of corresponding MTC groups associated with the MTC group identifier is provided.

In the above embodiment, the base station apparatuses 11 and 31, the MTC terminal apparatus 16, the MTC-GW apparatuses 27 and 37, or a part of the RN apparatus 48, for example, the registration processing unit 1111, the data setting unit 1113, the apparatus determining unit 1114, the address managing unit 1116, the data transfer unit 1118, the control units 116, 216, and 483, the communication processing unit 163, the power supply control unit 168, and the corresponding MTC information determining unit 3114 may be implemented by a computer. In this case, implementation may be performed such that a program for implementing the control function is recorded on a computer readable recording medium, and the program recorded in the recording medium is read to and executed in a computer system. Here, the “computer system” is a computer system equipped in the base station apparatuses 11 and 31, the MTC terminal apparatus 16, the MTC-GW apparatuses 27 and 37, or the RN apparatus 48 and assumed to include an operating system (OS) or hardware such as a peripheral apparatus. Further, the “computer readable recording medium” refers to a portable medium such as a flexible disk, an optical disc, a magneto optical disc, a ROM, or a CD-ROM or a memory apparatus such as a hard disk built in a computer system. Further, the “computer readable recording medium” may include a medium dynamically holding a program for a short period of time such as a communication line when a program is transmitted via a network such as the Internet or a communication line such as a telephone line and a medium holding a program for a certain period of time such as a voltage memory in a computer system serving as a server or a client in this case. Further, the program may implement some functions described above, and may implement the above-described function in combination with a program previously stored in a computer system.

Further, in the above embodiment, all or some of the base station apparatuses 11 and 31, the MTC terminal apparatus 16, the MTC-GW apparatuses 27 and 37, and the RN apparatus 48 may be implemented as an integrated circuit (IC) such as large scale integration (LSI). Each of the functional blocks of the base station apparatuses 11 and 31, the MTC terminal apparatus 16, the MTC-GW apparatuses 27 and 37, and the RN apparatus 48 may be implemented by a processor, and all or some of the functional blocks may be integrated and implemented by a processor. Further, an IC technique is not limited to the LSI, and implementation may be performed by a dedicated circuit or a general-purpose processor. Further, when an IC technique replacing the LSI is developed with the advance of semiconductor technology, an IC by such technique may be used.

The exemplary embodiments of the invention have been described above in detail with reference to the appended drawings, but a concrete constitution is not limited to the above embodiments, and various design changes or the like can be made within the scope not departing from the gist of the invention.

### INDUSTRIAL APPLICABILITY

The present invention can be applied to a communication system, a gateway apparatus, and a communication method which are capable of reducing a load of an MME.

### REFERENCE SYMBOLS

1, 2, 3, 4, 5 . . . Communication system
11, 21, 31, 41 . . . Base station apparatus
111, 311 . . . MTC-GW unit
1111 . . . Registration processing unit
1113 . . . Data setting unit
1114 . . . Apparatus determining unit
1115 . . . MTC information storage unit
1116 . . . Address managing unit
1117 . . . Address storage unit
1118 . . . Data transfer unit
3113 . . . Corresponding MTC information storage unit
3114 . . . Corresponding MTC information determining unit
112, 212, 272 . . . CN communication processing unit
113, 273 . . . Wired IF unit
114 . . . Wireless communication processing unit
115 . . . Wireless IF unit
116, 216 . . . Control unit
12 . . . MME
13 . . . HSS
14 . . . S/P-GW apparatus
15 . . . MTC server apparatus
16 . . . MTC terminal apparatus
161 . . . CPU
162 . . . Storage unit
163 . . . Communication processing unit
164 . . . Wireless IF unit
165 . . . Sensor unit
166 . . . A/D converting unit
167 . . . Timer unit
168 . . . Power supply control unit
169 . . . Power supply
191, 291, 391, 491, 591 . . . Core network
192 . . . Wide area network
193, 293, 393, 493, 593 . . . Radio access network
27, 37 . . . MTC-GW apparatus
48 . . . RN apparatus
483 . . . Control unit
484 . . . Wireless communication processing unit
485 . . . Wireless IF unit

1. A communication system, comprising:
a first gateway apparatus;
a second gateway apparatus configured to transfer data received from the first gateway apparatus to a first communication apparatus related to at least one of a certain group and service; and
a mobility management apparatus configured to perform a process of setting a communication path between a communication apparatus that transmits data and the second gateway apparatus,
wherein, the first gateway apparatus comprises:
an apparatus determining unit configured to receive a connection request signal for requesting a connection from the second communication apparatus and identify at least one of the group and service based on the connection request signal; and
a data transfer unit configured to transfer data received from the second communication apparatus to the second gateway apparatus.

2. The communication system according to claim 1,
wherein the first gateway apparatus comprises an address managing unit configured to allocate different addresses to the second communication apparatus.

3. The communication system according to claim 1,
wherein the first gateway apparatus comprises a control unit configured to transfer the connection request signal to the mobility management apparatus in case that at least one of the group and service is not identified.

4. The communication system according to claim 1, further comprising a third gateway apparatus, the third gateway apparatus comprising:
an apparatus determining unit configured to receive a connection request signal for requesting a connection from the second communication apparatus and identify at least one of the group and service based on the connection request signal; and
a corresponding information determining unit configured to decide the first gateway apparatus related to at least one of a group and service corresponding to at least one of the group and service.

5. A communication system, comprising:
a relay apparatus;
a base station apparatus configured to transfer data received from the relay apparatus;
a gateway apparatus configured to transmit data received from the base station apparatus to a first communication apparatus; and
a mobility management apparatus configured to perform a process of setting a communication path between a communication apparatus transmitting data and the gateway apparatus,
wherein the relay apparatus comprises:
an apparatus determining unit configured to receive a connection request signal for requesting a connection from the second communication apparatus and identify at least one of the group and service based on the connection request signal; and
a data transfer unit configured to transfer data received from the second communication apparatus to the gateway apparatus.

6. The communication system according to claim 5,
wherein the relay apparatus comprises a control unit configured to decide the number of communication apparatuses to be accommodated based on at least one of the number of communication apparatuses present and a communication capability of the communication apparatuses.

7. The communication system according to claim 5,
wherein the relay apparatus comprises a control unit configured to decide a service quality for communication apparatuses to be accommodated based on at least one of the number of communication apparatuses present and a communication capability of the communication apparatuses.

8. The communication system according to claim 5,
wherein the relay apparatus comprises a control unit configured to decide whether to transfer data received only from a communication apparatus related to at least one of the group and service based on at least one of the number of communication apparatuses present and a communication capability of the communication apparatuses.

9. A gateway apparatus, comprising:
a registration processing unit configured to transmit a registration request signal representing that a communication apparatus transmitting data requests a registration to a mobility management apparatus that performs a process of setting a communication path between the communication apparatus and another gateway apparatus;
a connection processing unit configured to establish the communication path with the other gateway apparatus after the mobility management apparatus sets the communication path; and
a data transfer unit configured to transfer data received from a communication apparatus related to at least one of a certain group and service to the other gateway apparatus.

10. A communication method in a communication system comprising a first gateway apparatus, a second gateway apparatus configured to transfer data received from the first gateway apparatus to a first communication apparatus related to at least one of a certain group and service, and a mobility management apparatus configured to perform a process of setting a communication path between a communication apparatus that transmits data and the second gateway apparatus, the communication method comprising:
receiving, by the first gateway apparatus, a connection request signal for requesting a connection from the communication apparatus and identifying at least one of the group and service based on the connection request signal, and
transferring, by the first gateway apparatus, data received from the communication apparatus to the second gateway apparatus.
